(19) United States
(12) Patent Application Publication
(10) Pub. No.: US 2020/0193357 A1
(43) Pub. Date: Jun. 18, 2020

(54) SYSTEMS AND METHODS FOR ALLOCATING SERVICE REQUESTS

(71) Applicant: BEIJING DIDI INFINITY TECHNOLOGY AND DEVELOPMENT CO., LTD., Beijing (CN)

(72) Inventors: Zhao SUN, Beijing (CN); Qiao LI, Hangzhou (CN); Guanqiao HE, Beijing (CN)

(73) Assignee: BEIJING DIDI INFINITY TECHNOLOGY AND DEVELOPMENT CO., LTD., Beijing (CN)

(21) Appl. No.: 16/732,046

(22) Filed: Dec. 31, 2019

Related U.S. Application Data
(63) Continuation of application No. PCT/CN2018/125394, filed on Dec. 29, 2018.

(30) Foreign Application Priority Data
Jun. 19, 2018 (CN) 201810629925.0
Jun. 19, 2018 (CN) 201810631116.3

(51) Int. Cl. G06Q 10/06; G06N 20/20; G06N 7/00

(52) U.S. Cl. CPC G06Q 10/063112; G06Q 50/30; G06N 7/005; G06N 20/20

(57) ABSTRACT

The present disclosure relates to systems and methods for allocating service requests. The systems may obtain service request information associated with a service request to be allocated and provider information associated with each of a plurality of candidate service providers. The systems may also determine a matching degree of each of the plurality of candidate service providers based on the service request information and the provider information. The systems may determine the matching degree based on a probability of accidents which may be predicted based on a prediction model. The systems may further determine a target service provider based on the matching degree of each of the plurality of candidate service providers and allocate the service request to the target service provider.

### CROSS-REFERENCE TO RELATED APPLICATIONS

This application is a continuation of International Application No. PCT/CN2018/125394, filed on Dec. 29, 2018, which designates the United States of America and claims priority to Chinese Patent Application No. 201810629925.0 filed on Jun. 19, 2018 and Chinese Patent Application No. 201810631116.3 filed on Jun. 19, 2018, the contents of which are hereby incorporated by reference in their entirety.

### TECHNICAL FIELD

The present disclosure generally relates to systems and methods for allocating service requests, and in particular, to systems and methods for allocating service requests based on machine learning.

### BACKGROUND

Internet transportation appointment service is a major branch of current Internet services. In the Internet transportation appointment service, in order to allocate service requests reasonably, the Internet transportation platform may perform a comprehensive calculation with respect to service request allocation.

During a transportation service, a driver and a passenger may spend a long time together in a vehicle, therefore, a bad behavior (e.g., a drunkenness) of one party may greatly influence the quality of the transportation service and may even result in a bad result (e.g., a personal conflict). A drunkenness of a user is an important cause of conflict in the vehicle and is one of induction factors in some cases such as human injury, sexual harassment, etc. Meanwhile, it is also a main reason for the driver to complain about the passenger, which greatly reduces the drivers' satisfaction with the transportation platform. Therefore, it is desirable to provide systems and methods for predicting conflict probabilities associated with service requests and allocating the service requests based on the conflict probabilities.

### SUMMARY

An aspect of the present disclosure relates to a method for allocating service requests. The method may include obtaining service request information of a service request to be allocated and feature information of a plurality of candidate service providers corresponding to the service request to be allocated; determining a matching degree of each of the plurality of candidate service providers based on the service request information of the service request to be allocated and the feature information of the plurality of candidate service providers corresponding to the service request to be allocated; determining a target service provider based on the matching degree of each of the plurality of candidate service providers; and allocating the service request to be allocated to the target service provider.

In some embodiments, the determining the matching degree of each of the plurality of candidate service providers based on the service request information of the service request to be allocated and the feature information of the plurality of candidate service providers corresponding to the service request to be allocated may include determining an allocation parameter associated with each of the plurality of candidate service providers and the service request to be allocated based on the service request information of service request to be allocated and the feature information of the plurality of candidate service providers; predicting a conflict probability of each of the plurality of candidate service providers corresponding to service request to be allocated; determining a matching weight based on the conflict probability; and determining a matching degree of each of the plurality of candidate service providers based on the allocation parameter and the matching weight.

In some embodiments, the determining the matching degree of each of the plurality of candidate service providers based on the allocation parameter and the matching weight may include determining a preliminary matching degree of each of the plurality of candidate service providers based on the allocation parameter; and obtaining the matching degree of each of the plurality of candidate service providers by updating the preliminary matching degree based on the matching weight.

In some embodiments, the service request information of the service request to be allocated may include a start time, a start location, a city where the service request is initiated, weather information of the city, a density of conflict service orders in the start location, an estimated mileage, a gender of the passenger, an age of the passenger, historical evaluation information of the passenger, a registration time of the passenger, and/or historical complaint records of the passenger. The feature information of each of the plurality of candidate service providers includes a gender of a driver, an age of the driver, historical evaluation records of the driver, a registration time of the driver, a service score of the driver, and/or order records of the driver. The allocation parameter may include a linear distance, a driving distance, an estimated travel time.

In some embodiments, the determining the matching weight based on the conflict probability may include in response to that the conflict probability is lower than a predetermined threshold, determining the matching weight corresponding to the conflict probability as 1; and in response to that the conflict probability is greater than or equal to the predetermined threshold, determining the matching weight according to a preset equation, wherein the preset equation is W=N^{C×p}^{²}^{+D×p}, where W refers to the matching weight, p refers to the conflict probability, N, C, and D refer to adjustable parameters.

Another aspect of the present disclosure relates to a system for allocating service requests. The system may include an obtaining module, a matching degree determination module, a target service provider determination module, and an allocation module. The obtaining module may be configured to obtain service request information of a service request to be allocated and feature information of a plurality of candidate service providers corresponding to the service request to be allocated. The matching degree determination module may be configured to determine a matching degree of each of the plurality of candidate service providers based on the service request information of the service request to be allocated and the feature information of the plurality of candidate service providers. The target service provider determination module may be configured to determine a target service provider based on the matching degree of each of the plurality of candidate service providers. The allocation module configured to allocate the service request to be allocated to the target service provider.

In some embodiments, the matching degree determination module may be specifically configured to determine an allocation parameter associated with each of the plurality of candidate service providers and the service request to be allocated based on the service request information of the service request to be allocated and the feature information of the plurality of candidate service providers; predict a conflict probability of each of the plurality of candidate service providers corresponding to service request to be allocated; determine a matching weight based on the conflict probability; and determine a matching degree of each of the plurality of candidate service providers based on the allocation parameter and the matching weight.

In some embodiments, the matching degree determination module may be specifically configured to determine a preliminary matching degree of each of the plurality of candidate service providers based on the allocation parameter; and obtain the matching degree of each of the plurality of candidate service providers by updating the preliminary matching degree based on the matching weight.

In some embodiments, the service request information of the service request to be allocated may include a start time, a start location, a city where the service request is initiated, weather information of the city, a density of conflict service orders in the start location, an estimated mileage, a gender of the passenger, an age of the passenger, historical evaluation information of the passenger, a registration time of the passenger, and/or historical complaint records of the passenger. The feature information of each of the plurality of candidate service providers includes a gender of a driver, an age of the driver, historical evaluation records of the driver, a registration time of the driver, a service score of the driver, and/or order records of the driver. The allocation parameter may include a linear distance, a driving distance, an estimated travel time.

In some embodiments, the matching degree determination module may be specifically configured to in response to that the conflict probability is lower than a predetermined threshold, determine the matching weight corresponding to the conflict probability as 1; and in response to that the conflict probability is greater than or equal to the predetermined threshold, determine the matching weight according to a preset equation, wherein the preset equation is W=N^{C×p}^{²}^{+D×p}, where W refers to the matching weight, p refers to the conflict probability, N, C, and D refer to adjustable parameters.

A further aspect of the present disclosure relates to a computer device including a storage, a processor, and a computer program stored on the storage and executed on the processor. When executing the computer program, the processor may implement the above method.

A still further aspect of the present disclosure relates to a computer readable storage medium storing a computer program thereon. When executing the computer program, a processor may implement the above method.

A still further aspect of the present disclosure relates to a method for predicting a probability of accidents associated with a service request. The method may include obtaining first service request information associated with a transportation service and vehicle information corresponding to the first service request; extracting first service request features included in the first service request information and first driver features of the vehicle; and predicting a probability of accidents associated with the first service request based on the first service request features and the first driver features according to a first prediction model.

In some embodiments, the method may also include establishing the first prediction model before obtaining the first service request information associated with the transportation service and the vehicle information corresponding to the first service request.

In some embodiments, the method may further include in response to that the probability of accidents associated with the first service request is higher than a predetermined threshold, marking the first service request.

In some embodiments, the establishing the first prediction model may include obtaining second service order information of second service orders which are used as samples and vehicle information corresponding to the second service orders; obtaining driver evaluation information in the second service order information and determining whether each of the second service orders is an accidental service order based on the driver evaluation information; in response to determining that the second service order is an accidental service order, extracting second service order features of the accidental service orders from the second service order information; extracting second driver features corresponding to the accidental service orders from the vehicle information corresponding to the second service orders; and training the first prediction model based on the second service order features and the second driver features.

In some embodiments, the second service order features may include a start time, a start location, a city where the service order is initiated, weather information of the city, a density of historical accidental service orders in the start location, an estimated mileage, a gender of the passenger, an age of the passenger, historical evaluation information of the passenger, and/or a registration time of the passenger. The second driver features include a gender of the driver, an age of the driver, historical evaluation information of the driver, a registration time of the driver, and/or a service score of the driver.

In some embodiments, the first prediction model may include an XGBoost model.

In some embodiments, the accident may include a conflict between a driver and a passenger.

A still further aspect of the present disclosure relates to a device for predicting a probability of accidents associated with a service request. The device may include a feature obtaining module and a prediction module. The feature obtaining module may be configured to obtain first service request information associated with a transportation service and vehicle information corresponding to the first service request and extract first service request features included in the first service request information and first driver features of the vehicle. The prediction module may be configured to predict a probability of accidents associated with the first service request based on the first service request features and the first driver features according to a first prediction model.

In some embodiments, the device may further include a model establishment module configured to establish the first prediction model.

In some embodiments, the device may further include a marking module configured to mark the first service request in response to that the probability of accidents associated with the first service request is higher than a predetermined threshold.

In some embodiments, the model establishment module may be specifically configured to obtain second service order information of second service orders which are used as samples and vehicle information corresponding to the second service orders; obtain driver evaluation information in the second service order information and determine whether each of the second service orders is an accidental service order based on the driver evaluation information; in response to determining that the second service order is an accidental service order, extract second service order features of the accidental service orders from the second service order information; extract second driver features corresponding to the accidental service orders from the vehicle information corresponding to the second service orders; and train the first prediction model based on the second service order features and the second driver features.

In some embodiments, the second service order features may include a start time, a start location, a city where the service order is initiated, weather information of the city, a density of historical accidental service orders in the start location, an estimated mileage, a gender of the passenger, an age of the passenger, historical evaluation information of the passenger, and/or a registration time of the passenger. The second driver features may include a gender of the driver, an age of the driver, historical evaluation information of the driver, a registration time of the driver, and/or a service score of the driver.

In some embodiments, the first prediction model may include an XGBoost model.

In some embodiments, the accident may include a conflict between a driver and a passenger.

A further aspect of the present disclosure relates to a computer device including a storage, a processor, and a computer program stored on the storage and executed on the processor. When executing the computer program, the processor may implement the above method.

A still further aspect of the present disclosure relates to a computer readable storage medium storing a computer program thereon. When executing the computer program, a processor may implement the above method

A still further aspect of the present disclosure relates to a system for allocating service requests. The system may include a storage medium to store a set of instructions and a processor communicatively coupled to the storage medium. The system may execute the set of instructions to obtain service request information associated with a service request to be allocated and provider information associated with each of a plurality of candidate service providers; determine a matching degree of each of the plurality of candidate service providers based on the service request information and the provider information; determine a target service provider based on the matching degree of each of the plurality of candidate service providers; and allocate the service request to the target service provider.

In some embodiments, the service request information may include at least one of a start time, a start location, a city where the service request is initiated, weather information of the city, a density of accidental service orders within a predetermined range of the start location, an estimated mileage, a gender of a service requester, an age of the service requester, historical evaluation information of the service requester, a registration time of the service requester, and/or complaint records of the service requester. The provider information of each of the plurality of candidate service providers may include at least one of a gender of the service provider, an age of the service provider, historical evaluation information of the service provider, a registration time of the service provider, a service score of the service provider, and/or historical service order records of the service provider.

In some embodiments, the system may determine an allocation parameter of each of the plurality of candidate service providers based on the service request information and the provider information. The system may predict a probability of accidents corresponding to each of the plurality of candidate service providers with respect to the service request. The system may determine a matching weight for each of the plurality of candidate service providers based on the probability of accidents. The system may determine the matching degree of each of the plurality of candidate service providers based on the allocation parameter and the matching weight.

In some embodiments, the allocation parameter may include at least one of a linear distance between a start location of the service request and a location of the candidate service provider, a driving distance between the start location of the service request and the location of the candidate service provider, and/or an estimated travel time from the location of the candidate service provider to the start location of the service request.

In some embodiments, the system may determine the matching weight as 1 in response to that the probability of accidents is lower than a predetermined threshold. The system may determine the matching weight inversely proportional to the probability of accidents in response to that the probability of accidents is larger than or equal to the predetermined threshold.

In some embodiments, the system may determine a preliminary matching degree of each of the plurality of candidate service providers based on the allocation parameter. The system may determine the matching degree of each of the plurality of candidate service providers by adjusting the preliminary matching degree based on the matching weight.

In some embodiments, the system may predict the probability of accidents corresponding to each of the plurality of candidate service providers with respect to the service request using a trained prediction model.

In some embodiments, the trained prediction model may be determined using a training process. The training process may include obtaining a plurality of historical service orders; extracting historical service order information from the plurality of historical service orders; determining a plurality of samples including a plurality of positive samples and a plurality of negative samples based on historical evaluation information in the historical service order information; and determining the trained prediction model based on the plurality of positive samples and the plurality of negative samples.

In some embodiments, the determining the trained prediction model based on the plurality of positive samples and the plurality of negative samples may include extracting sample features from each of the plurality of samples; obtaining a preliminary prediction model; determining a plurality of sample accident probabilities corresponding to the plurality of samples based on the preliminary prediction model and the sample features; determining whether the plurality of sample accident probabilities satisfy a preset condition; and designating the preliminary prediction model as the trained prediction model in response to that the plurality of sample accident probabilities satisfy the preset condition.

In some embodiments, the determining the trained prediction model based on the plurality of positive samples and the plurality of negative samples may further include updating the preliminary prediction model in response to that the plurality of sample accident probabilities do not satisfy the preset condition.

In some embodiments, the trained prediction model may include an Extreme Gradient Boosting (XGBoost) model.

A still further aspect of the present disclosure relates to a method implemented on a computing device including at least one processor, at least one storage medium, and a communication platform connected to a network. The method may include obtaining service request information associated with a service request to be allocated and provider information associated with each of a plurality of candidate service providers; determining a matching degree of each of the plurality of candidate service providers based on the service request information and the provider information; determining a target service provider based on the matching degree of each of the plurality of candidate service providers; and allocating the service request to the target service provider.

In some embodiments, the service request information may include at least one of a start time, a start location, a city where the service request is initiated, weather information of the city, a density of accidental service orders within a predetermined range of the start location, an estimated mileage, a gender of a service requester, an age of the service requester, historical evaluation information of the service requester, a registration time of the service requester, and/or complaint records of the service requester. The provider information of each of the plurality of candidate service providers includes at least one of a gender of the service provider, an age of the service provider, historical evaluation information of the service provider, a registration time of the service provider, a service score of the service provider, and/or historical service order records of the service provider.

In some embodiments, the determining the matching degree of each of the plurality of candidate service providers based on the service request information and the provider information may include determining an allocation parameter of each of the plurality of candidate service providers based on the service request information and the provider information; predicting a probability of accidents corresponding to each of the plurality of candidate service providers with respect to the service request; determining a matching weight for each of the plurality of candidate service providers based on the probability of accidents; and determining the matching degree of each of the plurality of candidate service providers based on the allocation parameter and the matching weight.

In some embodiments, the allocation parameter may include at least one of a linear distance between a start location of the service request and a location of the candidate service provider, a driving distance between the start location of the service request and the location of the candidate service provider, and/or an estimated travel time from the location of the candidate service provider to the start location of the service request.

In some embodiments, the determining the matching weight for each of the plurality of candidate service providers based on the probability of accidents may include determining the matching weight as 1 in response to that the probability of accidents is lower than a predetermined threshold; and determining the matching weight inversely proportional to the probability of accidents in response to that the probability of accidents is larger than or equal to the predetermined threshold.

In some embodiments, the determining the matching degree of each of the plurality of candidate service providers based on the allocation parameter and the matching weight may include determining a preliminary matching degree of each of the plurality of candidate service providers based on the allocation parameter; and determining the matching degree of each of the plurality of candidate service providers by adjusting the preliminary matching degree based on the matching weight.

In some embodiments, the predicting the probability of accidents corresponding to each of the plurality of service providers with respect to the service request may include predicting the probability of accidents corresponding to each of the plurality of candidate service providers with respect to the service request using a trained prediction model.

In some embodiments, the trained prediction model may be determined using a training process. The training process may include obtaining a plurality of historical service orders; extracting historical service order information from the plurality of historical service orders; determining a plurality of samples including a plurality of positive samples and a plurality of negative samples based on historical evaluation information in the historical service order information; and determining the trained prediction model based on the plurality of positive samples and the plurality of negative samples.

In some embodiments, the determining the trained prediction model based on the plurality of positive samples and the plurality of negative samples may include extracting sample features from each of the plurality of samples; obtaining a preliminary prediction model; determining a plurality of sample accident probabilities corresponding to the plurality of samples based on the preliminary prediction model and the sample features; determining whether the plurality of sample accident probabilities satisfy a preset condition; and designating the preliminary prediction model as the trained prediction model in response to that the plurality of sample accident probabilities satisfy the preset condition.

In some embodiments, the determining the trained prediction model based on the plurality of positive samples and the plurality of negative samples may include updating the preliminary prediction model in response to that the plurality of sample accident probabilities do not satisfy the preset condition.

In some embodiments, the trained prediction model may include an Extreme Gradient Boosting (XGBoost) model.

A still further aspect of the present disclosure relates to a system for allocating service requests. The system may include an obtaining module, a matching degree determination module, a target service provider determination module, and an allocation module. The obtaining module may be configured to obtain service request information associated with a service request to be allocated and provider information associated with each of a plurality of candidate service providers. The matching degree determination module may be configured to determine a matching degree of each of the plurality of candidate service providers based on the service request information and the provider information. The target service provider determination module may be configured to determine a target service provider based on the matching degree of each of the plurality of candidate service providers. The allocation module may be configured to allocate the service request to the target service provider.

In some embodiments, the service request information may include at least one of a start time, a start location, a city where the service request is initiated, weather information of the city, a density of accidental service orders within a predetermined range of the start location, an estimated mileage, a gender of a service requester, an age of the service requester, historical evaluation information of the service requester, a registration time of the service requester, and/or complaint records of the service requester. The provider information of each of the plurality of candidate service providers may include at least one of a gender of the service provider, an age of the service provider, historical evaluation information of the service provider, a registration time of the service provider, a service score of the service provider, and/or historical service order records of the service provider

In some embodiments, the matching degree determination module may be further configured to determine an allocation parameter of each of the plurality of candidate service providers based on the service request information and the provider information; predict a probability of accidents corresponding to each of the plurality of candidate service providers with respect to the service request; determine a matching weight for each of the plurality of candidate service providers based on the probability of accidents; and determine the matching degree of each of the plurality of candidate service providers based on the allocation parameter and the matching weight.

In some embodiments, the allocation parameter may include at least one of a linear distance between a start location of the service request and a location of the candidate service provider, a driving distance between the start location of the service request and the location of the candidate service provider, and/or an estimated travel time from the location of the candidate service provider to the start location of the service request.

In some embodiments, the matching degree determination module may be further configured to determine the matching weight as 1 in response to that the probability of accidents is lower than a predetermined threshold; and determine the matching weight inversely proportional to the probability of accidents in response to that the probability of accidents is larger than or equal to the predetermined threshold.

In some embodiments, the matching degree determination module may be further configured to determine a preliminary matching degree of each of the plurality of candidate service providers based on the allocation parameter; and determine the matching degree of each of the plurality of candidate service providers by adjusting the preliminary matching degree based on the matching weight.

In some embodiments, the matching degree determination module may be further configured to predict the probability of accidents corresponding to each of the plurality of candidate service providers with respect to the service request using a trained prediction model.

In some embodiments, the system may further include a model establishment module configured to determine the trained prediction model using a training process. The training process may include obtaining a plurality of historical service orders; extracting historical service order information from the plurality of historical service orders; determining a plurality of samples including a plurality of positive samples and a plurality of negative samples based on historical evaluation information in the historical service order information; and determining the trained prediction model based on the plurality of positive samples and the plurality of negative samples.

In some embodiments, the determining the trained prediction model based on the plurality of positive samples and the plurality of negative samples may include extracting sample features from each of the plurality of samples; obtaining a preliminary prediction model; determining a plurality of sample accident probabilities corresponding to the plurality of samples based on the preliminary prediction model and the sample features; determining whether the plurality of sample accident probabilities satisfy a preset condition; and designating the preliminary prediction model as the trained prediction model in response to that the plurality of sample accident probabilities satisfy the preset condition.

In some embodiments, the determining the trained prediction model based on the plurality of positive samples and the plurality of negative samples may include updating the preliminary prediction model in response to that the plurality of sample accident probabilities do not satisfy the preset condition.

In some embodiments, the trained prediction model may include an Extreme Gradient Boosting (XGBoost) model.

A still further aspect of the present disclosure relates to a non-transitory computer readable medium including executable instructions. When the executable instructions are executed by at least one processor, the executable instructions may direct the at least one processor to perform a method. The method may include obtaining service request information associated with a service request to be allocated and provider information associated with each of a plurality of candidate service providers; determining a matching degree of each of the plurality of candidate service providers based on the service request information and the provider information; determining a target service provider based on the matching degree of each of the plurality of candidate service providers; and allocating the service request to the target service provider.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary on-demand service system according to some embodiments of the present disclosure;

FIG. 2 is a schematic diagram illustrating exemplary hardware and/or software components of an exemplary computing device according to some embodiments of the present disclosure;

FIG. 3 is a schematic diagram illustrating exemplary hardware and/or software components of an exemplary mobile device according to some embodiments of the present disclosure;

FIG. 4 is a flowchart illustrating an exemplary process for allocating service requests according to some embodiments of the present disclosure;

FIG. 5 is a flowchart illustrating an exemplary process for allocating service requests according to some embodiments of the present disclosure;

FIG. 6 is a flowchart illustrating an exemplary process for allocating service requests according to some embodiments of the present disclosure;

FIG. 7 is a schematic diagram illustrating an exemplary process for allocating service requests according to some embodiments of the present disclosure;

FIG. 8 is a block diagram illustrating an exemplary service request allocation system according to some embodiments of the present disclosure;

FIG. 9 is a flowchart illustrating an exemplary process for predicting a probability of accidents associated with a service request according to some embodiments of the present disclosure;

FIG. 10 is a flowchart illustrating an exemplary process for predicting a probability of accidents associated with a service request according to some embodiments of the present disclosure;

FIG. 11 is a flowchart illustrating an exemplary process for predicting a probability of accidents associated with a service request according to some embodiments of the present disclosure;

FIG. 12 is a block diagram illustrating an exemplary prediction device according to some embodiments of the present disclosure;

FIG. 13 is a block diagram illustrating an exemplary prediction device according to some embodiments of the present disclosure;

FIG. 14 is a schematic diagram illustrating an exemplary impact of the prediction model according to some embodiment of the present disclosure; and

FIG. 15 is a flowchart illustrating an exemplary process for determining a trained prediction model according to some embodiment of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawings, all of which form part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

Moreover, while the systems and methods disclosed in the present disclosure are described primarily regarding on-demand transportation services, it should also be understood that this is only one exemplary embodiment. The systems and methods of the present disclosure may be applied to any other kind of on-demand service. For example, the systems and methods of the present disclosure may be applied to transportation systems of different environments including land, ocean, aerospace, or the like, or any combination thereof. The vehicle of the transportation systems may include a taxi, a private car, a hitch, a bus, a train, a bullet train, a high-velocity rail, a subway, a vessel, an aircraft, a spaceship, a hot-air balloon, a driverless vehicle, or the like, or any combination thereof. The transportation system may also include any transportation system for management and/or distribution, for example, a system for sending and/or receiving an express. The application of the systems and methods of the present disclosure may include a webpage, a plug-in of a browser, a client terminal, a custom system, an internal analysis system, an artificial intelligence robot, or the like, or any combination thereof.

The terms “passenger,” “requester,” “requestor,” “service requester,” “service requestor,” and “customer” in the present disclosure are used interchangeably to refer to an individual, an entity or a tool that may request or order a service. Also, the terms “driver,” “provider,” “service provider,” and “supplier” in the present disclosure are used interchangeably to refer to an individual, an entity or a tool that may provide a service or facilitate the providing of the service. The term “user” in the present disclosure refers to an individual, an entity or a tool that may request a service, order a service, provide a service, or facilitate the providing of the service. In the present disclosure, terms “requester” and “requester terminal” may be used interchangeably, and terms “provider” and “provider terminal” may be used interchangeably.

The terms “request,” “service,” “service request,” and “order” in the present disclosure are used interchangeably to refer to a request that may be initiated by a passenger, a requester, a service requester, a customer, a driver, a provider, a service provider, a supplier, or the like, or any combination thereof. The service request may be accepted by any one of a passenger, a requester, a service requester, a customer, a driver, a provider, a service provider, or a supplier. The service request may be chargeable or free.

The positioning technology used in the present disclosure may include a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning technologies may be used interchangeably in the present disclosure.

An aspect of the present disclosure relates to systems and methods for allocating service requests. The systems of the present disclosure may obtain service request information (e.g., a start time, a start location) associated with a service request to be allocated and provider information (e.g., an age, a gender, historical evaluation information) associated with each of a plurality of candidate service providers. The systems may also determine a matching degree of each of the plurality of candidate service providers based on the service request information and the provider information. The systems may determine the matching degree based on a probability of accidents which may be predicted based on a prediction model. The systems may further determine a target service provider based on the matching degree of each of the plurality of candidate service providers and allocate the service request to the target service provider. According to the systems and methods of the present disclosure, a probability of accidents corresponding to a candidate service provider with respect to a service request can be predicted based on a prediction model and may be further used to determine a matching degree of the candidate service provider, which can improve the efficiency of the allocation of service requests.

It should be noted that online on-demand service, such as online taxi-hailing services, is a new form of service rooted only in post-Internet era. It provides technical solutions to users and service providers that could raise only in post-Internet era. In the pre-Internet era, when a passenger hails a taxi on the street, the taxi request and acceptance occur only between the passenger and one taxi driver that sees the passenger. If the passenger hails a taxi through a telephone call, the service request and acceptance may occur only between the passenger and one service provider (e.g., one taxi company or agent). Online taxi, however, allows a user of the service to real-time and automatically distribute a service request to a vast number of individual service providers (e.g., taxi) distance away from the user. It also allows a plurality of service providers to respond to the service request simultaneously and in real-time. Therefore, through the Internet, the on-demand service system may provide a much more efficient transaction platform for the users and the service providers that may never meet in a traditional pre-Internet on-demand service system.

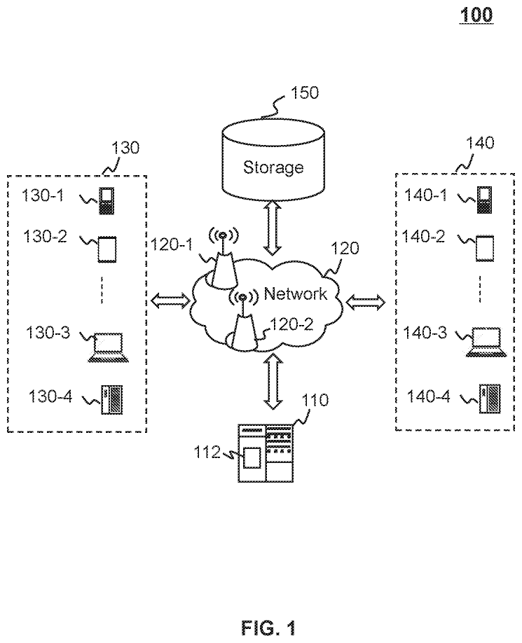

FIG. 1 is a schematic diagram illustrating an exemplary on-demand service system according to some embodiments of the present disclosure. In some embodiments, the on-demand service system 100 may be a system for Online-to-Offline services. For example, the on-demand service system 100 may be an online transportation service platform for transportation services such as taxi hailing, chauffeur services, delivery vehicles, carpool, bus service, driver hiring, shuttle services, etc. The on-demand service system 100 may be a platform including a server 110, a network 120, a requester terminal 130, a provider terminal 140, and a storage 150.

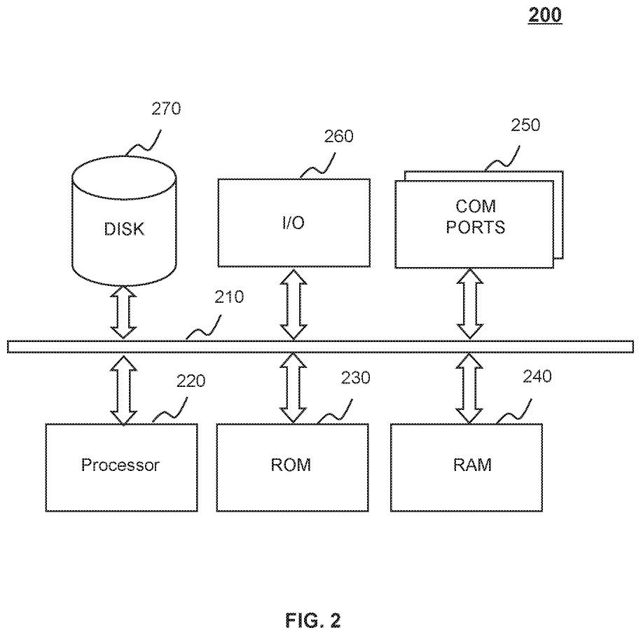

In some embodiments, the server 110 may be a single server or a server group. The server group may be centralized or distributed (e.g., server 110 may be a distributed system). In some embodiments, the server 110 may be local or remote. For example, the server 110 may access information and/or data stored in the requester terminal 130, the provider terminal 140, and/or the storage 150 via the network 120. As another example, the server 110 may be directly connected to the requester terminal 130, the provider terminal 140, and/or the storage 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 including one or more components illustrated in FIG. 2 in the present disclosure.

In some embodiments, the server 110 may include a processing engine 112. The processing engine 112 may process information and/or data relating to a service request to perform one or more functions of the server 110 described in the present disclosure. For example, the processing engine 112 may obtain service request information associated with a service request to be allocated and provider information associated with each of a plurality of candidate service providers, identify a target service provider based on the service request information and the provider information, and allocate the service request to the target service provider. In some embodiments, the processing engine 112 may include one or more processing engines (e.g., single-core processing engine(s) or multi-core processor(s)). Merely by way of example, the processing engine 112 may include one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof. In some embodiments, the processing engine 112 may be integrated in the requester terminal 130 or the provider terminal 140.

The network 120 may facilitate exchange of information and/or data. In some embodiments, one or more components (e.g., the server 110, the requester terminal 130, the provider terminal 140, the storage 150) of the on-demand service system 100 may transmit information and/or data to other component(s) of the on-demand service system 100 via the network 120. In some embodiments, the network 120 may be any type of wired or wireless network, or combination thereof. Merely by way of example, the network 120 may include a cable network, a wireline network, an optical fiber network, a tele communications network, an intranet, an Internet, a local area network (LAN), a wide area network (WAN), a wireless local area network (WLAN), a metropolitan area network (MAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the on-demand service system 100 may be connected to the network 120 to exchange data and/or information.

In some embodiments, a service requester may be a user of the requester terminal 130. In some embodiments, the user of the requester terminal 130 may be someone other than the service requester. For example, a user A of the requester terminal 130 may use the requester terminal 130 to transmit a service request for a user B, or receive a service confirmation and/or information or instructions from the server 110. In some embodiments, a service provider may be a user of the provider terminal 140. In some embodiments, the user of the provider terminal 140 may be someone other than the service provider. For example, a user C of the provider terminal 140 may use the provider terminal 140 to receive a service request for a user D, and/or information or instructions from the server 110. In some embodiments, “service requester” and “requester terminal” may be used interchangeably, and “service provider” and “provider terminal” may be used interchangeably.

In some embodiments, the requester terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistant (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass™, a RiftCon™, a Fragments™, a Gear VR™, etc. In some embodiments, the built-in device in the motor vehicle 130-4 may include an onboard computer, an onboard television, etc. In some embodiments, the requester terminal 130 may be a device with positioning technology for locating the position of the requester and/or the requester terminal 130.

In some embodiments, the provider terminal 140 may be similar to, or the same device as the requester terminal 130. In some embodiments, the provider terminal 140 may be a device with positioning technology for locating the position of the provider and/or the provider terminal 140. In some embodiments, the provider terminal 140 may periodically transmit GPS data to the server 110. In some embodiments, the requester terminal 130 and/or the provider terminal 140 may communicate with another positioning device to determine the position of the requester, the requester terminal 130, the provider, and/or the provider terminal 140. In some embodiments, the requester terminal 130 and/or the provider terminal 140 may transmit positioning information to the server 110.

The storage 150 may store data and/or instructions. In some embodiments, the storage 150 may store data obtained from the requester terminal 130 and/or the provider terminal 140. In some embodiments, the storage 150 may store data and/or instructions that the server 110 may execute or use to perform exemplary methods described in the present disclosure. In some embodiments, the storage 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage 150 may be connected to the network 120 to communicate with one or more components (e.g., the server 110, the requester terminal 130, the provider terminal 140) of the on-demand service system 100. One or more components of the on-demand service system 100 may access the data or instructions stored in the storage 150 via the network 120. In some embodiments, the storage 150 may be directly connected to or communicate with one or more components (e.g., the server 110, the requester terminal 130, the provider terminal 140) of the on-demand service system 100. In some embodiments, the storage 150 may be part of the server 110.

In some embodiments, one or more components (e.g., the server 110, the requester terminal 130, the provider terminal 140) of the on-demand service system 100 may access the storage 150. In some embodiments, one or more components of the on-demand service system 100 may read and/or modify information relating to the requester, the provider, and/or the public when one or more conditions are met. For example, the server 110 may read and/or modify one or more users' information after a service. As another example, the provider terminal 140 may access information relating to the requester when receiving a service request from the requester terminal 130, but the provider terminal 140 may not modify the relevant information of the requester.

In some embodiments, information exchanging of one or more components of the on-demand service system 100 may be achieved by way of requesting a service. The object of the service request may be any product. In some embodiments, the product may be a tangible product, or immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistant (PDA), a smart watch, a point of sale (POS) device, an onboard computer, an onboard television, a wearable device, or the like, or any combination thereof. For example, the product may be any software and/or application used on the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle), a car (e.g., a taxi, a bus, a private car), a train, a subway, a vessel, an aircraft (e.g., an airplane, a helicopter, a space shuttle, a rocket, a hot-air balloon), or the like, or any combination thereof.

One of ordinary skill in the art would understand that when an element of the on-demand service system 100 performs, the element may perform through electrical signals and/or electromagnetic signals. For example, when a requester terminal 130 processes a task, such as making a determination, identifying or selecting an object, the requester terminal 130 may operate logic circuits in its processor to process such task. When the requester terminal 130 sends out a service request to the server 110, a processor of the service requester terminal 130 may generate electrical signals encoding the service request. The processor of the requester terminal 130 may then send the electrical signals to an output port. If the requester terminal 130 communicates with the server 110 via a wired network, the output port may be physically connected to a cable, which may further transmit the electrical signals to an input port of the server 110. If the requester terminal 130 communicates with the server 110 via a wireless network, the output port of the requester terminal 130 may be one or more antennas, which may convert the electrical signals to electromagnetic signals. Similarly, a provider terminal 140 may process a task through operation of logic circuits in its processor, and receive an instruction and/or service request from the server 110 via electrical signals or electromagnet signals. Within an electronic device, such as the requester terminal 130, the provider terminal 140, and/or the server 110, when a processor thereof processes an instruction, sends out an instruction, and/or performs an action, the instruction and/or action is conducted via electrical signals. For example, when the processor retrieves or saves data from a storage medium (e.g., the storage 150), it may send out electrical signals to a read/write device of the storage medium, which may read or write structured data in the storage medium. The structured data may be transmitted to the processor in the form of electrical signals via a bus of the electronic device. Here, an electrical signal refers to one electrical signal, a series of electrical signals, and/or a plurality of distinguish electrical signals.

FIG. 2 is a schematic diagram illustrating exemplary hardware and/or software components of an exemplary computing device according to some embodiments of the present disclosure. In some embodiments, the server 110, the requester terminal 130, and/or the provider terminal 140 may be implemented on the computing device 200. For example, the processing engine 112 may be implemented on the computing device 200 and configured to perform functions of the processing engine 112 disclosed in this disclosure.

The computing device 200 may be used to implement any component of the on-demand service system 100 as described herein. For example, the processing engine 112 may be implemented on the computing device 200, via its hardware, software program, firmware, or a combination thereof. Although only one such computer is shown, for convenience, the computer functions relating to the on-demand service as described herein may be implemented in a distributed fashion on a number of similar platforms, to distribute the processing load.

The computing device 200, for example, may include COM ports 250 connected to and from a network connected thereto to facilitate data communications. The computing device 200 may also include a processor (e.g., the processor 220), in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The computing device 200 may further include program storage and data storage of different forms including, for example, a disk 270, and a read only memory (ROM) 230, or a random access memory (RAM) 240, for storing various data files to be processed and/or transmitted by the computing device. The exemplary computing device may also include program instructions stored in the ROM 230, RAM 240, and/or other type of non-transitory storage medium to be executed by the processor 220. The methods and/or processes of the present disclosure may be implemented as the program instructions. The computing device 200 also includes an I/O component 260, supporting input/output between the computer and other components. The computing device 200 may also receive programming and data via network communications.

Merely for illustration, only one CPU and/or processor is illustrated in FIG. 2. Multiple CPUs and/or processors are also contemplated; thus operations and/or method operations performed by one CPU and/or processor as described in the present disclosure may also be jointly or separately performed by the multiple CPUs and/or processors. For example, if in the present disclosure the CPU and/or processor of the computing device 200 executes both operation A and operation B, it should be understood that operation A and operation B may also be performed by two different CPUs and/or processors jointly or separately in the computing device 200 (e.g., the first processor executes operation A and the second processor executes operation B, or the first and second processors jointly execute operations A and B).

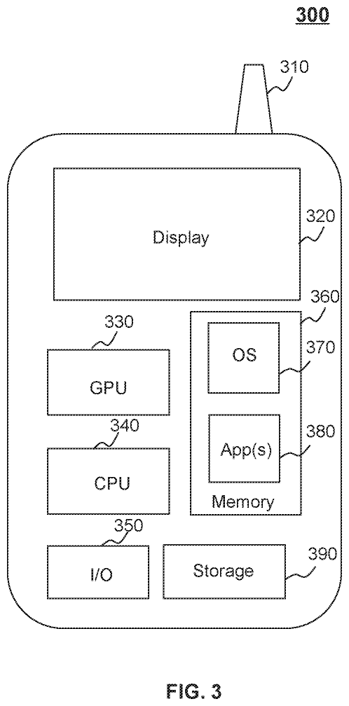

FIG. 3 is a schematic diagram illustrating exemplary hardware and/or software components of an exemplary mobile device according to some embodiments of the present disclosure. In some embodiments, the requester terminal 130 or the provider terminal 140 may be implemented on the computing device 300. As illustrated in FIG. 3, the mobile device 300 may include a communication platform 310, a display 320, a graphic processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300.

In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to on-demand services or other information from the on-demand service system 100. User interactions with the information stream may be achieved via the I/O 350 and provided to the processing engine 112 and/or other components of the on-demand service system 100 via the network 120.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

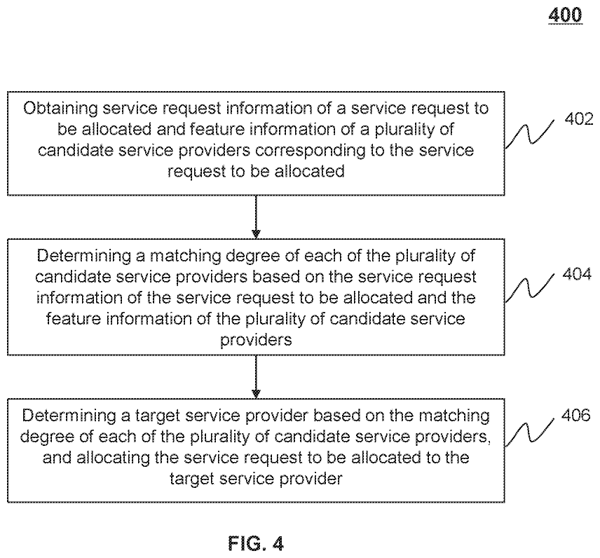

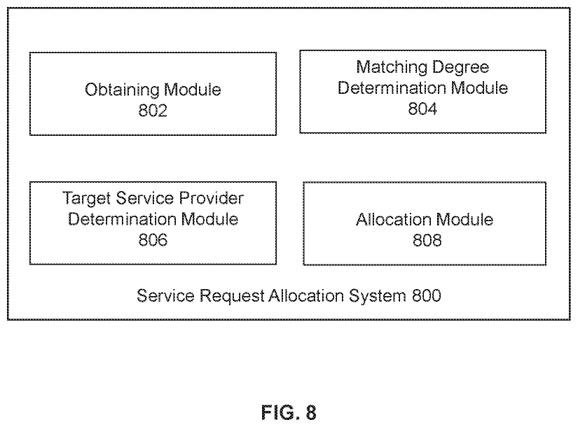

FIG. 4 is a flowchart illustrating an exemplary process for allocating service requests according to some embodiments of the present disclosure. The process 400 may be executed by the on-demand service system 100. For example, the process 400 may be implemented as a set of instructions stored in the storage ROM 230 or RAM 240. The processor 220 and/or the modules in FIG. 8 may execute the set of instructions, and when executing the instructions, the processor 220 and/or the modules may be configured to perform the process 400. The operations of the illustrated process presented below are intended to be illustrative. In some embodiments, the process 400 may be accomplished with one or more additional operations not described and/or without one or more of the operations discussed. Additionally, the order in which the operations of the process 400 illustrated in FIG. 4 and described below is not intended to be limiting.

In 402, service request information of a service request to be allocated and feature information (also referred to as “provider information”) of a plurality of candidate service providers corresponding to the service request to be allocated may be obtained.

In 404, a matching degree of each of the plurality of candidate service providers may be determined based on the service request information of the service request to be allocated and the feature information of the plurality of candidate service providers.

In 406, a target service provider may be determined based on the matching degree of each of the plurality of candidate service providers, and the service request to be allocated may be allocated to the target service provider.

According to the service request allocation method provided in the present disclosure, when a user initiates a service request, service request information of the service request to be allocated and feature information of a plurality of candidate service providers corresponding to the service request to be allocated may be obtained. The service request information and the feature information of the plurality of candidate service providers may be comprehensively considered to determine a matching degree of each of the plurality of candidate service providers. A target candidate service provider (i.e., a service provider who is most suitable to accept the service request) may be determined based on the matching degree of each of the plurality of candidate service providers and the service request to be allocated may be allocated to the target service provider. According to the technical solution of the present disclosure, a service request may be allocated based on a combination of service request information of the service request and feature information of a plurality of candidate service providers, which can make that a service provider who would accept the service request is most matched with the passenger and furthermore make that a probability that the driver may conflict with the passenger is minimized and a success rate of allocating service requests is improved.

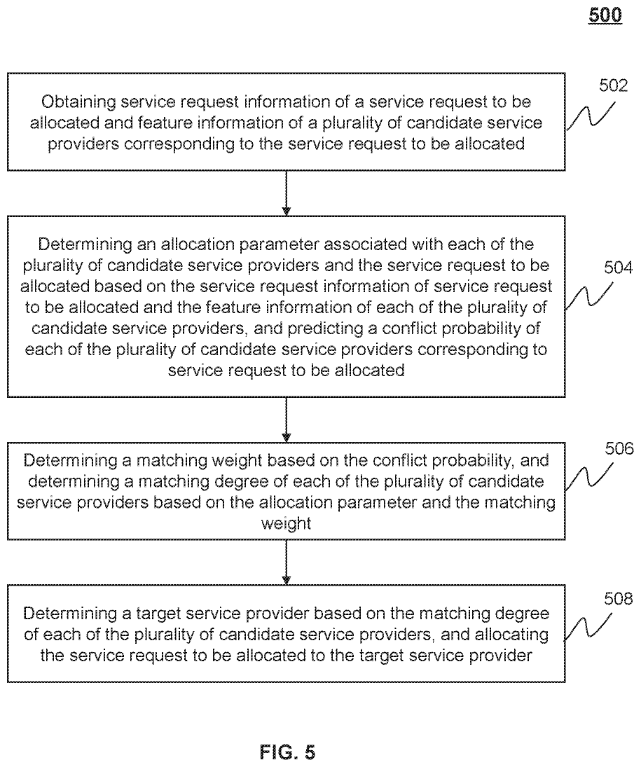

FIG. 5 is a flowchart illustrating an exemplary process for allocating service requests according to some embodiments of the present disclosure. The process 500 may be executed by the on-demand service system 100. For example, the process 500 may be implemented as a set of instructions stored in the storage ROM 230 or RAM 240. The processor 220 and/or the modules in FIG. 8 may execute the set of instructions, and when executing the instructions, the processor 220 and/or the modules may be configured to perform the process 500. The operations of the illustrated process presented below are intended to be illustrative. In some embodiments, the process 500 may be accomplished with one or more additional operations not described and/or without one or more of the operations discussed. Additionally, the order in which the operations of the process 500 illustrated in FIG. 5 and described below is not intended to be limiting.

In 502, service request information of a service request to be allocated and feature information of a plurality of candidate service providers corresponding to the service request to be allocated may be obtained.

In 504, an allocation parameter associated with each of the plurality of candidate service providers and the service request to be allocated may be determined based on the service request information of service request to be allocated and the feature information of the plurality of candidate service providers, and a conflict probability of each of the plurality of candidate service providers corresponding to the service request to be allocated (also referred to as a “probability of accidents corresponding to each of the plurality of candidate service providers with respect to the service request”) may be predicted. It should be noted that the present disclosure describes a conflict probability as an example, while allocating service requests, a probability associated with other accidents (e.g., traffic violation) may also be taken into consideration.

In 506, a matching weight may be determined based on the conflict probability, and a matching degree of each of the plurality of candidate service providers may be determined based on the allocation parameter and the matching weight.

In 508, a target service provider may be determined based on the matching degree of each of the plurality of candidate service providers, and the service request to be allocated may be allocated to the target service provider.

In this embodiment, an allocation parameter associated with each of the plurality of candidate service providers and the service request to be allocated may be determined based on the service request information of service request to be allocated and the feature information of each of the plurality of candidate service providers. The allocation parameter may be, for example, a parameter such as a distance between a location (e.g., a start location) of the service request to be allocated and a location of the candidate service provider, etc. Further, a conflict probability of each of the plurality of candidate service providers corresponding to service request to be allocated may be predicted, the conflict probability may be converted into a matching weight, and then a matching degree may be determined by applying the matching weight to the matching degree. A candidate service provider corresponding to a matching degree with a highest value among the matching degrees corresponding to the plurality of candidate service providers may be determined as a target service provider. According to the technical solution of the present disclosure, the plurality of candidate service providers may be ranked based on the conflict probabilities, which can ensure that a service provider who is most suitable to accept the service request may be determined based on the allocation parameter and the conflict probability.

Preferably, in 506, the determining of the matching degree of each of the plurality of candidate service providers based on the allocation parameter and the matching weight may include determining a preliminary matching degree of each of the plurality of candidate service providers based on the allocation parameter and obtaining the matching degree of each of the plurality of candidate service providers by updating (or adjusting) the preliminary matching degree based on the matching weight.

In this embodiment, a preliminary matching degree of each of the plurality of candidate service providers may be determined based on the allocation parameter. Further, the matching degree of each of the plurality of candidate service providers may be obtained by updating the preliminary matching degree based on the matching weight, so that the matching degree may be accurately obtained and the flexibility and accuracy of allocating service requests may be improved.

Preferably, the service request information of the service request to be allocated may include a start time, a start location, a city where the service request is initiated, weather information of the city, a density of conflict service orders (also referred to as “accidental service orders”) in the start location, an estimated mileage, a gender of the passenger, an age of the passenger, historical evaluation information of the passenger, a registration time of the passenger, historical complaint records of the passenger, or the like, or a combination thereof. As used herein, a conflict service order refers to a historical service order of which the passenger and the service provider conflicted with each other, accordingly the density of conflict service orders in the start location refers to a density of conflict orders within a predetermined time period (e.g., last month, last three months) within a predetermined range (e.g., 1 km, 5 km) of the start location. The feature information of each of the plurality of candidate service providers may include a gender of the driver, an age of the driver, historical evaluation records of the driver, a registration time of the driver, a service score of the driver, historical service order records of the driver, or the like, or a combination thereof. The allocation parameter may include a linear distance between the start location of the service request and a location of the candidate service provider, a driving distance between the start location of the service request and the location of the candidate service provider, an estimated travel time from the location of the candidate service provider to the start location of the service request, or the like, or a combination thereof.

In this embodiment, the service request information of the service request to be allocated and the feature information of each of the plurality of candidate service providers may include but not limited to the above information. The conflict probability of each of the plurality of candidate service providers corresponding to the service request to be allocated may be predicted based on a combination of the service request information of the service request to be allocated and the feature information of each of the plurality of candidate service providers. For example, if the start time of the service request is nighttime, the start location is a place such as a bar, a restaurant, and the historical complaint records of the passenger indicate that complaints due to drunkenness are relatively more, then the passenger may be analyzed as a drunk passenger. Furthermore, if a number count of complaints about passengers being drunk in the historical evaluation information of the candidate service provider is relatively high, and a number count of complaints from passengers is relatively high, then it may be analyzed that the candidate service provider may be prone to conflict with passengers, and it may be determined that a conflict probability of the candidate service provider corresponding to the service request to be allocated may be relatively high. The allocation parameter may include but not limited to the above information. When the matching is performed, a preliminary matching may be performed based on various parameters such as a linear distance, a driving distance, an estimated travel time, etc.

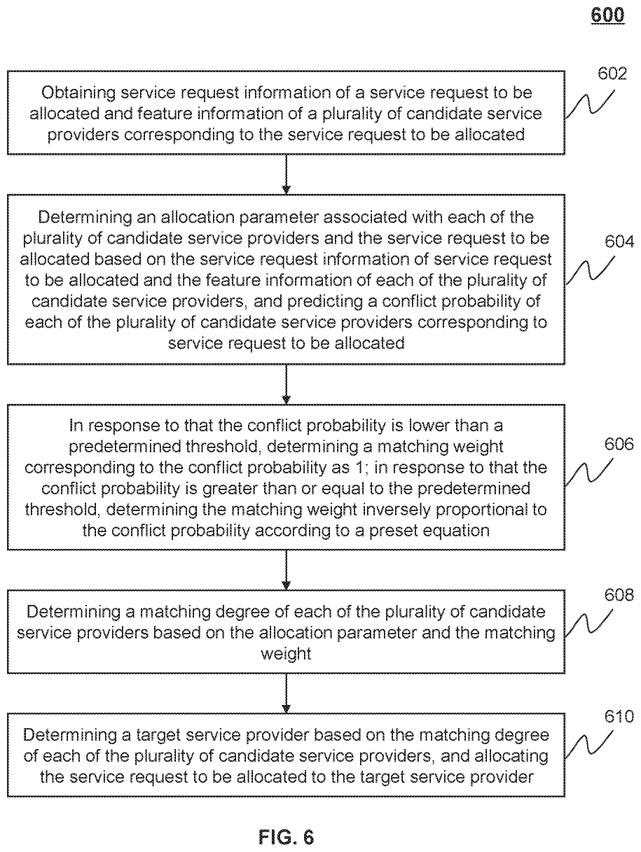

FIG. 6 is a flowchart illustrating an exemplary process for allocating service requests according to some embodiments of the present disclosure. The process 600 may be executed by the on-demand service system 100. For example, the process 600 may be implemented as a set of instructions stored in the storage ROM 230 or RAM 240. The processor 220 and/or the modules in FIG. 8 may execute the set of instructions, and when executing the instructions, the processor 220 and/or the modules may be configured to perform the process 600. The operations of the illustrated process presented below are intended to be illustrative. In some embodiments, the process 600 may be accomplished with one or more additional operations not described and/or without one or more of the operations discussed. Additionally, the order in which the operations of the process 600 illustrated in FIG. 6 and described below is not intended to be limiting.

In 602, service request information of a service request to be allocated and feature information of a plurality of candidate service providers corresponding to the service request to be allocated may be obtained.

In 604, an allocation parameter associated with each of the plurality of candidate service providers and the service request to be allocated may be determined based on the service request information of service request to be allocated and the feature information of each of the plurality of candidate service providers, and a conflict probability of each of the plurality of candidate service providers corresponding to service request to be allocated may be predicted.

In 606, in response to that the conflict probability is lower than a predetermined threshold, a matching weight corresponding to the conflict probability may be determined as 1; in response to that the conflict probability is greater than or equal to the predetermined threshold, the matching weight may be determined inversely proportional to the conflict probability according to a preset equation, wherein, the preset equation is expressed as below:

W=N^{C×p}^{²}^{+D×p} (1)

where W refers to the matching weight, p refers to the conflict probability, N, C, and D refer to predetermined parameters which may be default settings of the on-demand service system 100 or may be adjustable under different situations.

In 608, a matching degree of each of the plurality of candidate service providers may be determined based on the allocation parameter and the matching weight.

In 610, a target service provider may be determined based on the matching degree of each of the plurality of candidate service providers, and the service request to be allocated may be allocated to the target service provider.

In this embodiment, a candidate service provider with a conflict probability lower than the predetermined threshold may be regarded as a service provider with a low conflict probability and a matching weight of the service provider may be determined as 1, that is, for service providers with a low conflict probability, no intervention may be introduced, thereby minimizing the negative impact on a transaction rate. A candidate service provider with a conflict probability greater than or equal to the predetermined threshold may be regarded as a service provider with a high conflict probability and the matching weight of the service provider may be determined according to the preset equation (1), that is, an intervention may be introduced for service providers with a high conflict probability, a weight reduction may be performed on the service providers with a high conflict probability, and the greater the conflict probability is, the more the weight reduction may be, thereby minimizing the conflict probability between the driver and the passenger.

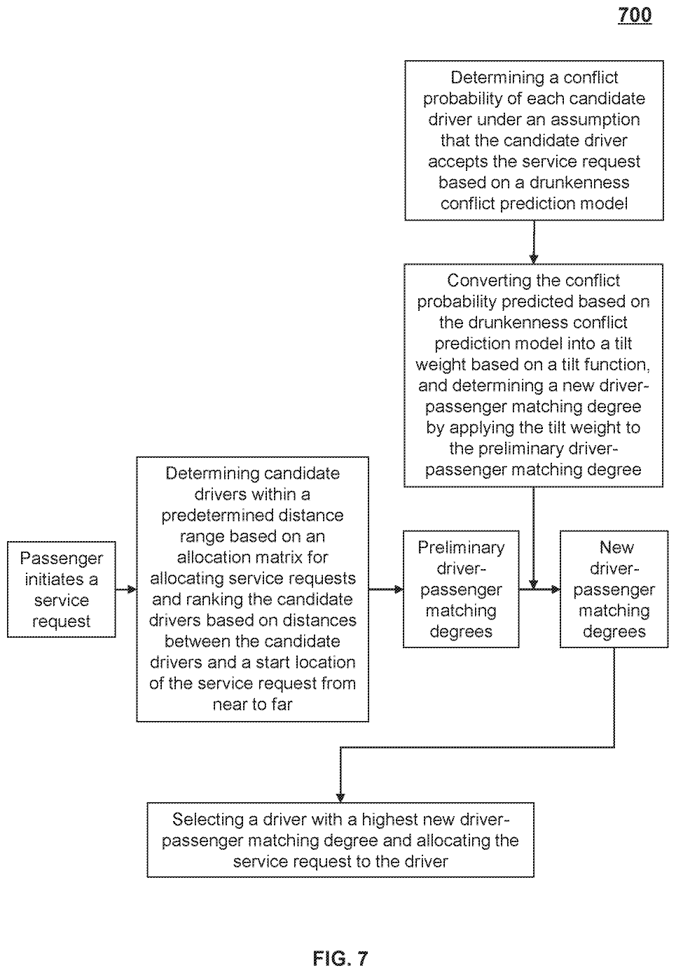

FIG. 7 is a schematic diagram illustrating an exemplary process for allocating service requests according to some embodiments of the present disclosure.

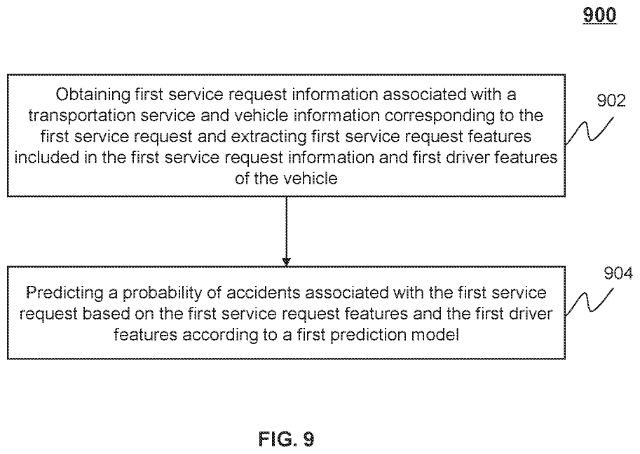

As illustrated, when a passenger initiates a service request, available drivers (i.e., candidate drivers) within a predetermined distance range may be determined based on an allocation matrix for allocating service requests, the available drivers may be ranked based on distances between the available drivers and a start location of the service request from near to far, and preliminary driver-passenger matching degrees may be determined. Meanwhile, a conflict probability of each candidate driver under an assumption that the candidate driver accepts the service request may be determined based on a drunkenness conflict prediction model (e.g., a prediction model described in FIGS. 9-14). The conflict probability predicted based on the drunkenness conflict prediction model may be converted into a tilt weight based on a tilt function and a new driver-passenger matching degree may be determined by applying the tilt weight to the preliminary driver-passenger matching degree. The new driver-passenger matching degrees may be ranked from high to low, a driver with a highest new driver-passenger matching degree may be selected, and the service request may be allocated to the driver. As used herein, the conflict probability of each candidate driver may be determined based on the drunkenness conflict prediction model before the driver accepts the service request, which can minimize the conflict probability between the driver who would accept the service request and the passenger. It may inevitably result in a negative impact on a business indicator (e.g., a transaction rate, an allocation distance, etc.) to introduce an intervention to the existing allocation mode by using the drunkenness conflict prediction model, therefore, the tilt function may be determined to reduce an incidence rate of the drunkenness conflicts and control the impact on business indicators within an acceptable range.

The drunkenness conflict prediction model may be an Extreme Gradient Boosting (XGBoost) model which may be a machine learning function library that focuses on gradient lifting algorithms. Drunkenness orders (also referred to as “drunkenness service orders”) may be obtained based on evaluation information associated with orders (e.g., evaluation information from drivers, evaluation information from passengers). For example, for a specific order, if the evaluation information from the driver indicates that the passenger is drunk and the evaluation information from the passenger indicates that the driver has a bad attitude, it may be determined that the specific order is a drunkenness order and a conflict occurred between the driver and the passenger. Further, features associated with the drunkenness orders and features associated with the conflict information between the drivers and passengers may be extracted and the drunkenness conflict prediction model may be established based on the features. The features associated with the drunkenness order may include a start time, a start location, an estimated mileage, a gender of a user (e.g., a passenger, a driver), an age of the user, historical complaints of the user, etc. More descriptions of the drunkenness conflict prediction model may be found elsewhere in the present disclosure (e.g., FIGS. 9-15 and the descriptions thereof).

In some embodiments, an objective of the tilt function may be: firstly, the conflict probability between the finally selected driver (i.e., the target driver) and the passenger is minimized; secondly, the negative impact on the transaction rate is minimized. A constraint condition of the tilt function may be: firstly, the weight is inversely proportional to the conflict probability, the greater the conflict probability is, the more the weight reduction may be; secondly, according to a consideration of reducing the transaction rate, an intervention is introduced only for drivers with a high conflict probability and no intervention is introduced for drivers with a low conflict probability. According to the above considerations, the tilt function is designated as: in response to that the conflict probability p is lower than a high conflict probability threshold x, a matching weight corresponding to the conflict probability may be determined as 1; in response to that the conflict probability p is greater than or equal to the high conflict probability threshold x, the matching weight may be determined according to equation (1).

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

FIG. 8 is a block diagram illustrating an exemplary service request allocation system according to some embodiments of the present disclosure. The service request allocation system 800 may include an obtaining module 802, a matching degree determination module 804, a target service provider determination module 806, and an allocation module 808. In some embodiments, the service request allocation system 800 may be integrated into the server 110. For example, the service request allocation system 800 may be part of the processing engine 112.

The obtaining module 802 may be configured to obtain service request information of a service request to be allocated and feature information of a plurality of candidate service providers corresponding to the service request to be allocated.

The matching degree determination module 804 may be configured to determine a matching degree of each of the plurality of candidate service providers based on the service request information of the service request to be allocated and the feature information of the plurality of candidate service providers.

The target service provider determination module 806 may be configured to determine a target service provider based on the matching degree of each of the plurality of candidate service providers.

The allocation module 808 may be configured to allocate the service request to be allocated to the target service provider.

According to the service request allocation system 800 provided in the present disclosure, when a user initiates a service request, service request information of the service request to be allocated and feature information of a plurality of candidate service providers corresponding to the service request to be allocated may be obtained. The service request information and the feature information of the plurality of candidate service providers may be comprehensively considered to determine a matching degree of each of the plurality of candidate service providers. A target candidate service provider (i.e., a service provider who is most suitable to accept the service request) may be determined based on the matching degree of each of the plurality of candidate service providers and the service request to be allocated may be allocated to the target service provider. According to the technical solution of the present disclosure, a service request may be allocated based on a combination of service request information of the service request and feature information of a plurality of candidate service providers, which can make that a service provider who would accept the service request is most matched with the passenger and furthermore make that a probability that the driver may conflict with the passenger is minimized and a success rate of allocating service requests is improved.

Preferably, the matching degree determination module 804 may be specifically configured to determine an allocation parameter associated with each of the plurality of candidate service providers and the service request to be allocated based on the service request information of service request to be allocated and the feature information of each of the plurality of candidate service providers; predict a conflict probability of each of the plurality of candidate service providers corresponding to the service request to be allocated; determine a matching weight based on the conflict probability, and determine a matching degree of each of the plurality of candidate service providers based on the allocation parameter and the matching weight.

In this embodiment, an allocation parameter associated with each of the plurality of candidate service providers and the service request to be allocated may be determined based on the service request information of service request to be allocated and the feature information of each of the plurality of candidate service providers. The allocation parameter may be, for example, a parameter such as a distance between a location (e.g., a start location) of the service request to be allocated and a location of the candidate service provider, etc. Further, a conflict probability of each of the plurality of candidate service providers corresponding to service request to be allocated may be predicted, the conflict probability may be converted into a matching weight, and then a matching degree may be determined by applying the matching weight to the matching degree. A candidate service provider corresponding to a matching degree with a highest value among the matching degrees corresponding to the plurality of candidate service providers may be determined as a target service provider. According to the technical solution of the present disclosure, the plurality of candidate service providers may be ranked based on the conflict probabilities, which can ensure that a service provider who is most suitable to accept the service request may be determined based on the allocation parameter and the conflict probability.

Preferably, the matching degree determination module 804 may be specifically configured to determine a preliminary matching degree of each of the plurality of candidate service providers based on the allocation parameter and obtain the matching degree of each of the plurality of candidate service providers by updating (or adjusting) the preliminary matching degree based on the matching weight.

In this embodiment, a preliminary matching degree of each of the plurality of candidate service providers may be determined based on the allocation parameter. Further, the matching degree of each of the plurality of candidate service providers may be obtained by updating the preliminary matching degree based on the matching weight, so that the matching degree may be accurately obtained and the flexibility and accuracy of allocating service requests may be improved.

Preferably, the service request information of the service request to be allocated may include a start time, a start location, a city where the service request is initiated, weather information of the city, a density of conflict service orders in the start location, an estimated mileage, a gender of the passenger, an age of the passenger, historical evaluation information of the passenger, a registration time of the passenger, historical complaint records of the passenger, or the like, or a combination thereof. The feature information of each of the plurality of candidate service providers may include a gender of the driver, an age of the driver, historical evaluation records of the driver, a registration time of the driver, a service score of the driver, historical service order records of the driver, or the like, or a combination thereof. The allocation parameter may include a linear distance between the start location of the service request and a location of the candidate service provider, a driving distance between the start location of the service request and the location of the candidate service provider, an estimated travel time from the location of the candidate service provider to the start location of the service request, or the like, or a combination thereof.

In this embodiment, the service request information of the service request to be allocated and the feature information of each of the plurality of candidate service providers may include but not limited to the above information. The conflict probability of each of the plurality of candidate service providers corresponding to the service request to be allocated may be predicted based on a combination of the service request information of the service request to be allocated and the feature information of each of the plurality of candidate service providers. For example, if the start time of the service request is nighttime, the start location is a place such as a bar, a restaurant, and the historical complaint records of the passenger indicates that complaints due to drunkenness are relatively more, then the passenger may be analyzed as a drunk passenger. Furthermore, if a number count of complaints about passengers being drunk in the historical evaluation information of the candidate service provider is relatively high, and a number count of complaints from passengers is relatively high, then it may be analyzed that the candidate service provider may be prone to conflict with passengers, and it may be determined that a conflict probability of the candidate service provider corresponding to the service request to be allocated may be relatively high. The allocation parameter may include but not limited to the above information. When the matching is performed, a preliminary matching may be performed based on various parameters such as a linear distance, a driving distance, an estimated travel time, etc.

Preferably, the matching degree determination module 804 may be specifically configured to: in response to that the conflict probability is lower than a predetermined threshold, a matching weight corresponding to the conflict probability may be determined as 1; in response to that the conflict probability is greater than or equal to the predetermined threshold, the matching weight may be determined inversely proportional to the conflict probability according to equation (1).

In this embodiment, a candidate service provider with a conflict probability lower than the predetermined threshold may be regarded as a service provider with a low conflict probability and a matching weight of the service provider may be determined as 1, that is, for service providers with a low conflict probability, no intervention may be introduced, thereby minimizing the negative impact on a transaction rate. A candidate service provider with a conflict probability greater than or equal to the predetermined threshold may be regarded as a service provider with a high conflict probability and the matching weight of the service provider may be determined according to the preset equation (1), that is, an intervention may be introduced for service providers with a high conflict probability, a weight reduction may be performed on the service providers with a high conflict probability, and the greater the conflict probability is, the more the weight reduction may be, thereby minimizing the conflict probability between the driver and the passenger.

The modules in the service request allocation system 800 may be connected to or communicate with each other via a wired connection or a wireless connection. The wired connection may include a metal cable, an optical cable, a hybrid cable, or the like, or any combination thereof. The wireless connection may include a local area network (LAN), a wide area network (WAN), Bluetooth, a ZigBee network, near field communication (NFC), or the like, or any combination thereof. Two or more of the modules may be combined into a single module, and any one of the modules may be divided into two or more units. For example, the service request allocation system 800 may include a storage module (not shown) that may be used to store data generated by the above modules.

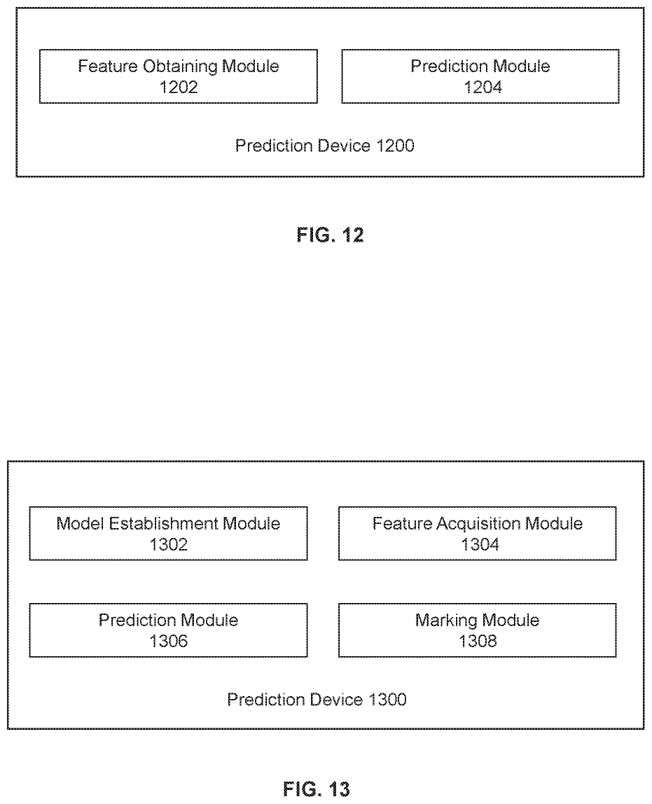

FIG. 9 is a flowchart illustrating an exemplary process for predicting a probability of accidents associated with a service request according to some embodiments of the present disclosure. The process 900 may be executed by the on-demand service system 100. For example, the process 900 may be implemented as a set of instructions stored in the storage ROM 230 or RAM 240. The processor 220 and/or the modules in FIGS. 12-13 may execute the set of instructions, and when executing the instructions, the processor 220 and/or the modules may be configured to perform the process 900. The operations of the illustrated process presented below are intended to be illustrative. In some embodiments, the process 900 may be accomplished with one or more additional operations not described and/or without one or more of the operations discussed. Additionally, the order in which the operations of the process 900 illustrated in FIG. 9 and described below is not intended to be limiting.

In 902, first service request information (i.e., information of a first service request) associated with a transportation service and vehicle information (i.e., information of a vehicle) corresponding to the first service request may be obtained, and first service request features (i.e., features of the first service request) included in the first service request information and first driver features (i.e., features of a first driver) of the vehicle may be extracted.

In 904, a probability of accidents (e.g., a drunkenness conflict described in FIGS. 4-8) associated with the first service request may be predicted based on the first service request features and the first driver features according to a first prediction model (e.g., the drunkenness conflict prediction model described in FIG. 7).

According to the method for predicting a drunkenness conflict associated with passengers provided in the present disclosure, first service request information (a service request initiated by a passenger) and vehicle information (i.e., a candidate vehicle which can be assigned to the passenger) corresponding to the first service request may be obtained, and first service request features and first driver features may be extracted. Further, the first service request features and the first driver features may be inputted into an established first prediction model and a probability (i.e., a probability of accidents under an assumption that the first service request is allocated to the first driver) of accidents associated with the first service request may be outputted. According to the technical solution of the present disclosure, it is possible to predict a probability of accidents before allocating a service request to a driver, thereby improving drivers' satisfaction with the online taxi hailing platform and ensuring the safety of drivers and passengers.

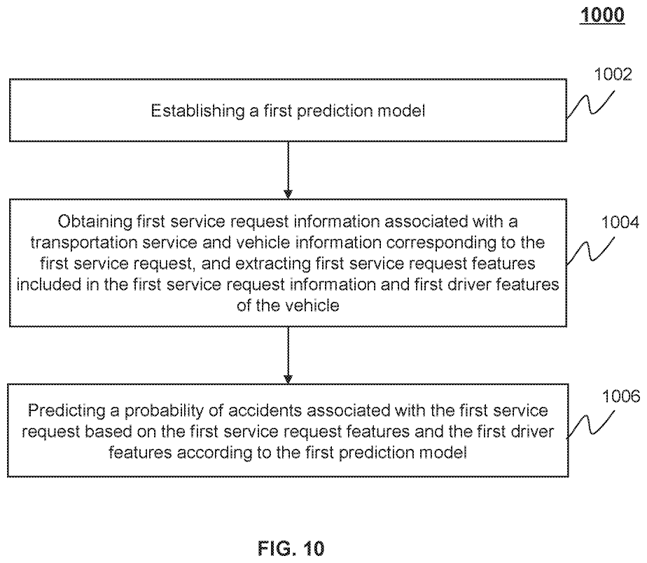

FIG. 10 is a flowchart illustrating an exemplary process for predicting a probability of accidents associated with a service request according to some embodiments of the present disclosure. The process 1000 may be executed by the on-demand service system 100. For example, the process 1000 may be implemented as a set of instructions stored in the storage ROM 230 or RAM 240. The processor 220 and/or the modules in FIGS. 12-13 may execute the set of instructions, and when executing the instructions, the processor 220 and/or the modules may be configured to perform the process 1000. The operations of the illustrated process presented below are intended to be illustrative. In some embodiments, the process 1000 may be accomplished with one or more additional operations not described and/or without one or more of the operations discussed. Additionally, the order in which the operations of the process 1000 illustrated in FIG. 10 and described below is not intended to be limiting.

In 1002, a first prediction model may be established.

In 1004, first service request information associated with a transportation service and vehicle information corresponding to the first service request may be obtained, and first service request features included in the first service request information and first driver features of the vehicle may be extracted.

In 1006, a probability of accidents (e.g., a drunkenness conflict described in FIGS. 4-8) associated with the first service request may be predicted based on the first service request features and the first driver features according to the first prediction model.

In this embodiment, a first prediction model may be established and the probability of accidents associated with the first service request may be predicted according to the first prediction model, then occurrences of accidents after service requests are allocated may be reduced.

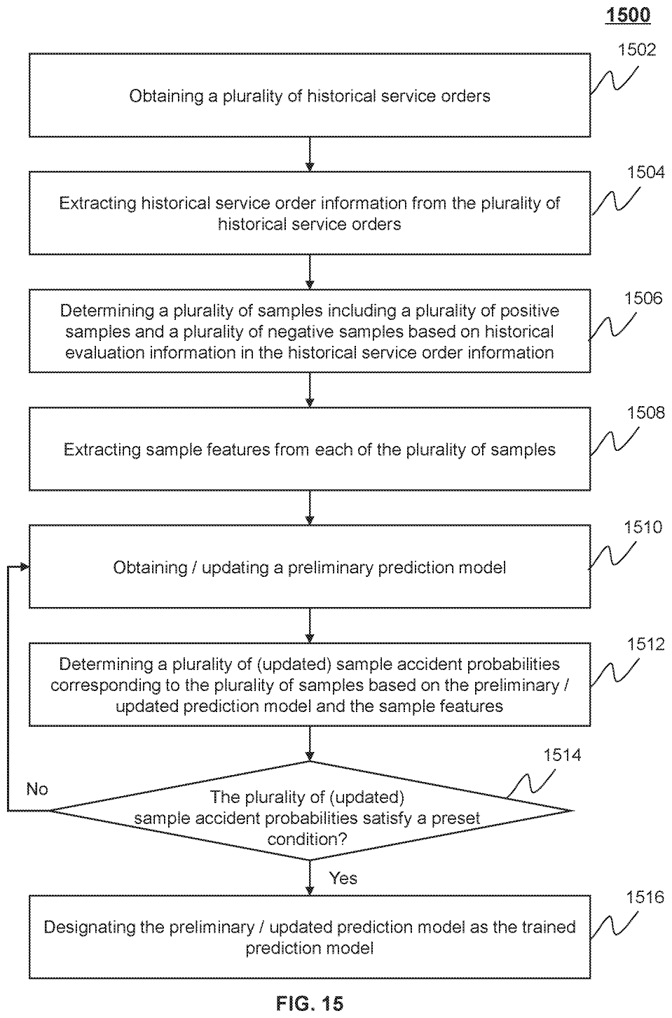

Preferably, the establishing of the first prediction model specifically includes: obtaining second service order information of second service orders (e.g., historical service orders) which are used as samples and vehicle information corresponding to the second service orders; obtaining driver evaluation information in the second service order information and determining whether each of the second service orders is an accidental service order based on the driver evaluation information; in response to determining that the second service order is an accidental service order, extracting second service order features of the accidental service orders from the second service order information; extracting second driver features corresponding to the accidental service orders from the vehicle information corresponding to the second service orders; training the first prediction model based on the second service order features and the second driver features. As used herein, the second service order features and the second driver features may be collectively referred to as “sample features.” More descriptions of the training of the first prediction model may be found elsewhere in the present disclosure (e.g., FIG. 15 and the descriptions thereof).

In this embodiment, with the development of the online taxi-hailing services, drivers and passengers can conveniently provide evaluation information associated with each other via the online taxi-hailing platform. Accordingly, a recognition may be performed on the evaluation information provided by the drivers via such as the online taxi-hailing application or telephone calls, and whether each of the second service orders is an accidental service order may be determined. Further, common features of the accidental service orders may be determined as the second service order features and corresponding second driver features may be extracted from the vehicle information corresponding to the second service order information. The first prediction model may be established by training the second service order features and the second driver features. According to the technical solution of the present disclosure, a large number of sample orders and sample vehicle information may be used to determine reasonable features, thereby establishing an accurate prediction model.

It should be noted that the probability of accidents (e.g., conflicts occurred in vehicles) is often a few parts per million, which means that a ratio of black samples (i.e., negative samples) to white samples (i.e., positive samples) reaches 1:1000000 (the black sample refers to a service order associated with which a conflict occurred and the white sample refers to a service order associated with which no conflict occurred). It is a huge challenge to establish a model under such a condition that the ratio of black samples to white samples is such out-of-balance in the field of machine learning. To this end, when the second service order information and the vehicle information corresponding to the second service order information are collected, a negative sampling test is frequently repeated to achieve a suitable ratio of black samples to white samples.

Preferably, the second service order features may include a start time, a start location, a city where the service order is initiated, weather information of the city, a density of historical accidental service orders in the start location, an estimated mileage, a gender of the passenger, an age of the passenger, historical evaluation information of the passenger, a registration time of the passenger, or the like, or a combination thereof. The second driver features may include a gender of the driver, an age of the driver, historical evaluation information of the driver, a registration time of the driver, a service score of the driver, or the like, or a combination thereof.

In this embodiment, the second service order features and the second driver features include but not limited to the above information, wherein, the historical evaluation information of the passenger includes a situation in which the passenger is complained by a driver and a situation in which the passenger complained a conflict with a driver, the historical evaluation information of the driver includes evaluation information to the driver provided by passengers and evaluation information to passengers provided by the driver. A first prediction model may be established based on a combination of the second service order features and the second driver features. For example, the common features of the accidental service orders include the start time of the service order being nighttime, the start location of the service order being in a place such as a bar, a restaurant, and the historical complaint records of the passenger indicating that complaints due to drunkenness are relatively more, and the second driver features corresponding to the accidental service orders include complaints to passengers being relatively more, historical complaints from passengers being relatively more, the driver being relatively young (a relatively young driver may be prone to conflict with passengers).

Preferably, the first prediction model may be an XGBoost model.

In this embodiment, the XGBoost model may be a machine learning function library that focuses on gradient lifting algorithms. According to the XGBoost model, a prediction model may be established by training the second service order features and the second driver features. On one hand, the XGBoost model has an excellent effect in solving classification problems; on the other hand, the algorithm is superior to artificial neural networks and the algorithm process is explicable.

Preferably, the accident may include a conflict (e.g., a drunkenness conflict) between a driver and a passenger.

In this embodiment, the accident may include a conflict between a driver and a passenger, and accordingly the first prediction model may be a drunkenness conflict probability prediction model, which may be used to predict a conflict probability associated with a specific passenger and a specific driver under an assumption that a specific service request initiated by the specific passenger is allocated to the specific driver.

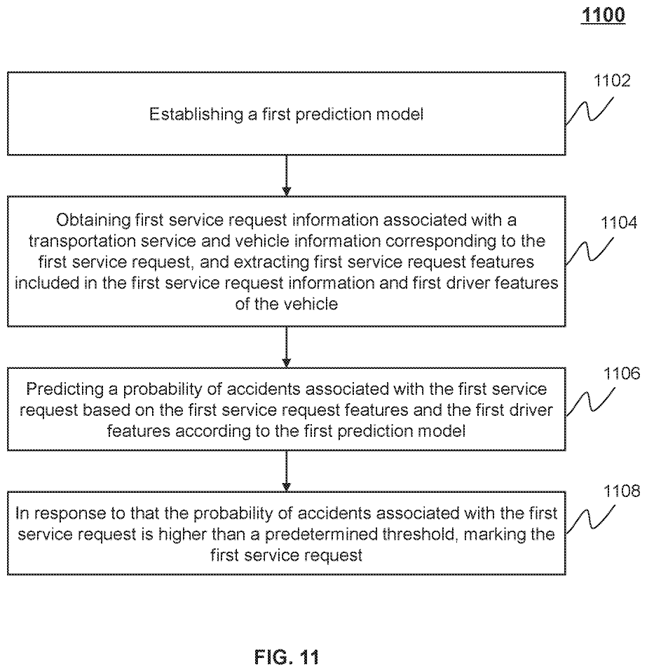

FIG. 11 is a flowchart illustrating an exemplary process for predicting a probability of accidents associated with a service request according to some embodiments of the present disclosure. The process 1100 may be executed by the on-demand service system 100. For example, the process 1100 may be implemented as a set of instructions stored in the storage ROM 230 or RAM 240. The processor 220 and/or the modules in FIGS. 12-13 may execute the set of instructions, and when executing the instructions, the processor 220 and/or the modules may be configured to perform the process 1100. The operations of the illustrated process presented below are intended to be illustrative. In some embodiments, the process 1100 may be accomplished with one or more additional operations not described and/or without one or more of the operations discussed. Additionally, the order in which the operations of the process 1100 illustrated in FIG. 11 and described below is not intended to be limiting.

In 1102, a first prediction model may be established.

In 1104, first service request information associated with a transportation service and vehicle information corresponding to the first service request may be obtained, and first service request features included in the first service request information and first driver features of the vehicle may be extracted.

In 1106, a probability of accidents associated with the first service request may be predicted based on the first service request features and the first driver features according to the first prediction model.

In 1108, in response to that the probability of accidents associated with the first service request is higher than a predetermined threshold, the first service request may be marked. In some embodiments, as described in connection with FIGS. 4-8, a matching weight may be determined for the driver based on the probability of accidents and further a matching degree of the driver may be determined based on the matching weight.

In this embodiment, in response to that the probability of accidents associated with the first service request is higher than a predetermined threshold, the first service request may be marked. Then a subsequent intervention may be introduced to reduce a probability of occurrence of accidents. In some embodiments, as described in connection with FIG. 6, the driver may be regarded as a driver with a high conflict probability and a matching weight may be determined for the driver according to equation (1).

Preferably, the establishing of the first prediction model specifically includes: obtaining second service order information of second service orders which are used as samples and vehicle information corresponding to the second service orders; obtaining driver evaluation information in the second service order information and determining whether each of the second service orders is an accidental service order based on the driver evaluation information; in response to determining that the second service order is an accidental service order, extracting second service order features of the accidental service orders from the second service order information; extracting second driver features corresponding to the accidental service orders from the vehicle information corresponding to the second service orders; training the first prediction model based on the second service order features and the second driver features. More descriptions of the training of the first prediction model may be found elsewhere in the present disclosure (e.g., FIG. 15 and the descriptions thereof).

Preferably, the second service order features may include a start time, a start location, a city where the service order is initiated, weather information of the city, a density of historical accidental service orders in the start location, an estimated mileage, a gender of the passenger, an age of the passenger, historical evaluation information of the passenger, a registration time of the passenger, or the like, or a combination thereof. The second driver features may include a gender of the driver, an age of the driver, historical evaluation information of the driver, a registration time of the driver, a service score of the driver, or the like, or a combination thereof. The first prediction model may be an XGBoost model.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

FIG. 12 is a block diagram illustrating an exemplary prediction device according to some embodiments of the present disclosure. The prediction device 1200 may include a feature obtaining module 1202 and a prediction module 1204. In some embodiments, the prediction device 1200 may be integrated into the server 110. For example, the prediction device 1200 may be part of the processing engine 112.

The feature obtaining module 1202 may be configured to obtain first service request information associated with a transportation service and vehicle information corresponding to the first service request, and extract first service request features included in the first service request information and first driver features of the vehicle.

The prediction module 1204 may be configured to predict a probability of accidents associated with the first service request based on the first service request features and the first driver features according to a first prediction model.

According to the prediction device 1200 provided in the present disclosure, first service request information (a service request initiated by a passenger) and vehicle information (i.e., a candidate vehicle which can be assigned to the passenger) corresponding to the first service request may be obtained, and first service request features and first driver features may be extracted. Further, the first service request features and the first driver features may be inputted into an established first prediction model and a probability (i.e., a probability of accidents under an assumption that the first service request is allocated to the first driver) of accidents associated with the first service request may be outputted. According to the technical solution of the present disclosure, it is possible to predict a probability of accidents before allocating a service request to a driver, thereby improving drivers' satisfaction with the online taxi hailing platform and ensuring the safety of drivers and passengers.

The modules in the prediction device 1200 may be connected to or communicate with each other via a wired connection or a wireless connection. The wired connection may include a metal cable, an optical cable, a hybrid cable, or the like, or any combination thereof. The wireless connection may include a local area network (LAN), a wide area network (WAN), Bluetooth, a ZigBee network, near field communication (NFC), or the like, or any combination thereof. Two or more of the modules may be combined into a single module, and any one of the modules may be divided into two or more units.

FIG. 13 is a block diagram illustrating an exemplary prediction device according to some embodiments of the present disclosure. The prediction device 1300 may include a model establishment module 1302, a feature obtaining module 1304, a prediction module 1306, and a marking module 1308. In some embodiments, the prediction device 1300 may be integrated into the server 110. For example, the prediction device 1300 may be part of the processing engine 112.

The model establishment module 1302 may be configured to establish a first prediction model.

The feature obtaining module 1304 may be configured to obtain first service request information associated with a transportation service and vehicle information corresponding to the first service request, and extract first service request features included in the first service request information and first driver features of the vehicle.

The prediction module 1306 may be configured to predict a probability of accidents associated with the first service request based on the first service request features and the first driver features according to the first prediction model.

The marking module 1308 may be configured to mark the first service request in response to that the probability of accidents associated with the first service request is higher than a predetermined threshold.

In this embodiment, a first prediction model may be established and the probability of accidents associated with the first service request may be predicted according to the first prediction model, then occurrences of accidents after service requests are allocated may be reduced.

In response to that the probability of accidents associated with the first service request is higher than a predetermined threshold, the first service request may be marked. Then a subsequent intervention may be introduced to reduce a probability of occurrence of accidents.

Preferably, the model establishment module 1302 may be specifically configured to: obtain second service order information of second service orders which are used as samples and vehicle information corresponding to the second service orders; obtain driver evaluation information in the second service order information and determine whether each of the second service orders is an accidental service order based on the driver evaluation information; in response to determining that the second service order is an accidental service order, extract second service order features of the accidental service orders from the second service order information; extract second driver features corresponding to the accidental service orders from the vehicle information corresponding to the second service orders; train the first prediction model based on the second service order features and the second driver features.

In this embodiment, with the development of the online taxi-hailing services, drivers and passengers can conveniently provide evaluation information associated with each other via the online taxi-hailing platform. Accordingly, a recognition may be performed on the evaluation information provided by the drivers via such as the online taxi-hailing application or telephone calls, and whether each of the second service orders is an accidental service order may be determined. Further, common features of the accidental service orders may be determined as the second service order features and corresponding second driver features may be extracted from the vehicle information corresponding to the second service order information. The first prediction model may be established by training the second service order features and the second driver features. According to the technical solution of the present disclosure, a large number of sample orders and sample vehicle information may be used to determine reasonable features, thereby establishing an accurate prediction model.

It should be noted that the probability of accidents (e.g., conflicts occurred in vehicles) is often a few parts per million, which means that a ratio of black samples (i.e., negative samples) to white samples (i.e., positive samples) reaches 1:1000000 (the black sample refers to a service order associated with which a conflict occurred and the white sample refers to a service order associated with which no conflict occurred). It is a huge challenge to establish a model under such a condition that the ratio of black samples to white samples is such out-of-balance in the field of machine learning. To this end, when the second service order information and the vehicle information corresponding to the second service order information are collected, a negative sampling test is frequently repeated to achieve a suitable ratio of black samples to white samples.

Preferably, the second service order features may include a start time, a start location, a city where the service order is initiated, weather information of the city, a density of historical accidental service orders in the start location, an estimated mileage, a gender of the passenger, an age of the passenger, historical evaluation information of the passenger, a registration time of the passenger, or the like, or a combination thereof. The second driver features may include a gender of the driver, an age of the driver, historical evaluation information of the driver, a registration time of the driver, a service score of the driver, or the like, or a combination thereof.

In this embodiment, the second service order features and the second driver features include but not limited to the above information, wherein, the historical evaluation information of the passenger includes a situation in which the passenger is complained by a driver and a situation in which the passenger complained a conflict with a driver, the historical evaluation information of the driver includes evaluation information to the driver provided by passengers and evaluation information to passengers provided by the driver. A first prediction model may be established based on a combination of the second service order features and the second driver features. For example, the common features of the accidental service orders include the start time of the service order being nighttime, the start location of the service order being in a place such as a bar, a restaurant, and the historical complaint records of the passenger indicating that complaints due to drunkenness are relatively more, and the second driver features corresponding to the accidental service orders include complaints to passengers being relatively more, historical complaints from passengers being relatively more, the driver being relatively young (a relatively young driver may be prone to conflict with passengers).

Preferably, the first prediction model may be an XGBoost model.

In this embodiment, the XGBoost model may be a machine learning function library that focuses on gradient lifting algorithms. According to the XGBoost model, a prediction model may be established by training the second service order features and the second driver features. On one hand, the XGBoost model has an excellent effect in solving classification problems; on the other hand, the algorithm is superior to artificial neural networks and the algorithm process is explicable.

Preferably, the accident may include a conflict (e.g., a drunkenness conflict) between a driver and a passenger.

In this embodiment, the accident may include a conflict between a driver and a passenger, and accordingly the first prediction model may be a drunkenness conflict probability prediction model, which may be used to predict a conflict probability associated with a specific passenger and a specific driver under an assumption that a specific service request initiated by the specific passenger is allocated to the specific driver.

The modules in the prediction device 1300 may be connected to or communicate with each other via a wired connection or a wireless connection. The wired connection may include a metal cable, an optical cable, a hybrid cable, or the like, or any combination thereof. The wireless connection may include a local area network (LAN), a wide area network (WAN), Bluetooth, a ZigBee network, near field communication (NFC), or the like, or any combination thereof. Two or more of the modules may be combined into a single module, and any one of the modules may be divided into two or more units.

A specific embodiment relates to a method for predicting a drunkenness conflict probability associated with passengers and the technical solution of the present disclosure can solve the following technical problems.

1. Marking of Drunkenness Service Orders

According to related arts, since service order information is transmitted offline, it is difficult to collect features (e.g., good evaluation information, complaints, etc.) of historical service orders. Further, since costs of telephone calls and other means are huge, it is almost impossible to implement a model that requires massive data. Therefore, how to solve the problem of marking drunkenness service orders becomes a first difficulty.

2. Feature Construction of Model

A drunkenness complaint rate of the online taxi-hailing platform is only two ten thousandths and a rate of drunkenness conflict is only parts per million, both of which are all small probability events and it is difficult to determine laws. Further, it is necessary to perform a reasonable feature construction for a prediction associated with drunkenness service requests. Therefore, how to determine features associated with drunkenness of passengers becomes a second difficulty.

3. Algorithm Selection

Recently, there are many algorithms used for classification, such as logistic regression, decision trees, support vector machines, artificial neural networks, etc. Therefore, how to choose a suitable model to provide a best solution to the current problem becomes a third difficulty.

For the three points, a specific embodiment of the present disclosure provides a method for establishing a prediction model for predicting drunkenness conflict associated with passengers, including:

1. Marking the Drunkenness Service Orders Based on Evaluation Information to Passengers Provided by Drivers

With the development of the online taxi-hailing services, drivers and passengers can conveniently provide evaluation information associated with each other via the online taxi-hailing platform. Accordingly, a recognition may be performed on the evaluation information provided by the drivers via such as the online taxi-hailing application or telephone calls, and whether each of the second service orders is an accidental service order may be determined. For example, for a specific service order, if the evaluation information from the driver indicates that the passenger is drunk and has a bad attitude, it may be determined that the specific service order is a drunkenness service order.

2. Constructing Drunkenness Related Features Through Correlation Analysis

According to large data analysis, drunkenness related features are found, such as a start time, a point of interest (POI) of a start location, an estimated mileage, and passenger features such as a gender, an age, a number count of historical complaints. Take the start time as an example, the analysis result indicates that an occurrence rate of drunkenness service orders significantly increases during nighttime. Further, start locations of drunkenness service orders are often concentrated in places such as bars, KTV, etc. The analysis result also indicates that a large part of designated driver orders are orders associated with drunkenness, start locations of which can be used to construct POI features of drunkenness service orders.

3. Model Construction

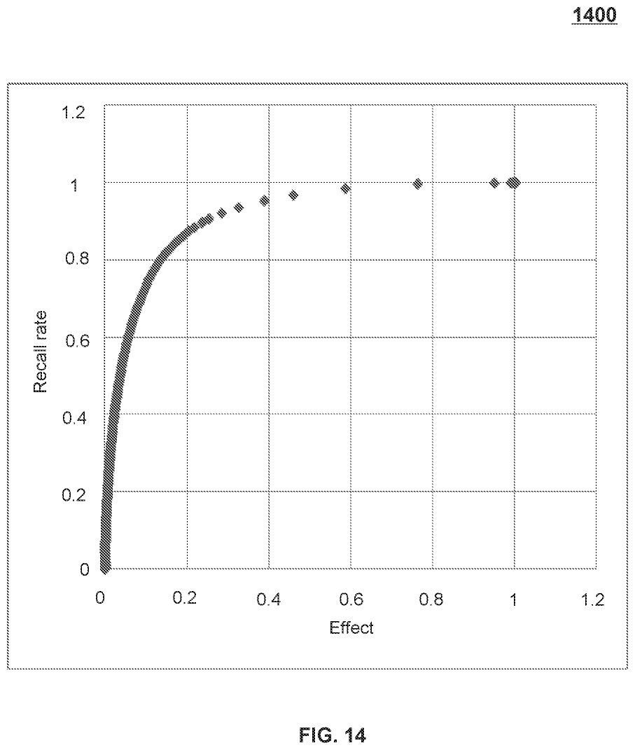

On one hand, the XGBoost model has an excellent effect in solving classification problems; on the other hand, the algorithm is superior to artificial neural networks and the algorithm process is explicable. According to the XGBoost algorithm, order features such as a start time, a point of interest (POI) of a start location, an estimated mileage, and passenger features such as a gender, an age, a number count of historical complaints are brought in a model and a drunkenness conflict prediction model is constructed. As shown in FIG. 14, according to the drunkenness conflict prediction model, 30% of the drunkenness service orders can be recalled under a situation that only 1% of the orders are affected.

FIG. 15 is a flowchart illustrating an exemplary process for determining a trained prediction model according to some embodiment of the present disclosure. The process 1500 may be executed by the on-demand service system 100. For example, the process 1500 may be implemented as a set of instructions stored in the storage ROM 230 or RAM 240. The processor 220 and/or the model establishment module 1302 may execute the set of instructions, and when executing the instructions, the processor 220 and/or the model establishment module 1302 may be configured to perform the process 1500. The operations of the illustrated process presented below are intended to be illustrative. In some embodiments, the process 1500 may be accomplished with one or more additional operations not described and/or without one or more of the operations discussed. Additionally, the order in which the operations of the process 1500 illustrated in FIG. 15 and described below is not intended to be limiting.

In 1502, the processing engine 112 (e.g., the model establishment module 1302) (e.g., the interface circuits of the processor 220) may obtain a plurality of historical service orders. The processing engine 112 may obtain the plurality of historical service orders from a storage device (e.g., the storage 150) disclosed elsewhere in the present disclosure.

In 1504, the processing engine 112 (e.g., the model establishment module 1302) (e.g., the processing circuits of the processor 220) may extract historical service order information (e.g., the second service order information illustrated in FIGS. 10-11) from the plurality of historical service orders.

In 1506, the processing engine 112 (e.g., the model establishment module 1302) (e.g., the processing circuits of the processor 220) may determine a plurality of samples including a plurality of positive samples and a plurality of negative samples based on historical evaluation information in the historical service order information. As described in connection with FIGS. 10-11, the positive sample refers to a historical service order associated with which no conflict between a historical service requester and a historical service provider occurred; the negative sample refers to a historical service order associated with which a conflict between a historical service requester and a historical service provider occurred. Further, the processing engine 112 may determine the trained prediction model based on the plurality of positive samples and the plurality of negative samples.

In 1508, the processing engine 112 (e.g., the model establishment module 1302) (e.g., the processing circuits of the processor 220) may extract sample features from each of the plurality of samples. As described in connection with FIGS. 10-11, take a specific historical service order as an example, the sample features may include a start time, a start location, a city where the historical service order is initiated, weather information of the city, a density of historical accidental service orders in the start location, an estimated mileage, a gender of the passenger, an age of the passenger, historical evaluation information of the passenger, a registration time of the passenger, a gender of the driver, an age of the driver, historical evaluation information of the driver, a registration time of the driver, a service score of the driver, or the like, or a combination thereof.

In 1510, the processing engine 112 (e.g., the model establishment module 1302) (e.g., the processing circuits of the processor 220) may obtain a preliminary prediction model. The preliminary prediction model may include one or more preliminary parameters which may be default settings of the on-demand service system 100 or may be adjustable under different situations.

In 1512, the processing engine 112 (e.g., the model establishment module 1302) (e.g., the processing circuits of the processor 220) may determine a plurality of sample accident probabilities corresponding to the plurality of samples based on the preliminary prediction model and the sample features.

In 1514, the processing engine 112 (e.g., the model establishment module 1302) (e.g., the processing circuits of the processor 220) may determine whether the plurality of sample accident probabilities satisfy a preset condition.

For example, the processing engine 112 may determine a loss function of the preliminary prediction model and determine a value of the loss function based on the plurality of sample accident probabilities. Further, the processing engine 112 may determine whether the value of the loss function is less than a loss threshold. The loss threshold may be default settings of the on-demand service system 100 or may be adjustable under different situations. In response to the determination that the value of the loss function is less than the loss threshold, the processing engine 112 may determine that the plurality of sample accident probabilities satisfy the preset condition. In response to the determination that the value of the loss function is higher than or equal to the loss threshold, the processing engine 112 may determine that the plurality of sample accident probabilities do not satisfy the preset condition.

As another example, the processing engine 112 may determine whether a number count of iterations is higher than an iteration threshold. In response to the determination that the number count of iterations is higher than the iteration threshold, the processing engine 112 may determine that the plurality of sample accident probabilities satisfy the preset condition. In response to the determination that the number count of iterations is less than or equal to the iteration threshold, the processing engine 112 may determine that plurality of sample accident probabilities do not satisfy the preset condition.

In response to the determination that plurality of sample accident probabilities satisfy the preset condition, the processing engine 112 (e.g., the model establishment module 1302) (e.g., the processing circuits of the processor 220) may designate the preliminary prediction model as the trained prediction model in 1516. On the other hand, in response to the determination that the plurality of sample accident probabilities do not satisfy the preset condition, the processing engine 112 may execute the process 1500 to return 1510 to update the preliminary prediction model. For example, the processing engine 112 may update the one or more preliminary parameters to produce an updated prediction model.

The processing engine 112 may also determine whether a plurality of updated sample accident probabilities determined based on the updated prediction model satisfy the preset condition. In response to the determination that the updated sample accident probabilities satisfy the preset condition, the processing engine 112 may designate the updated prediction model as the trained prediction model in 1516. On the other hand, in response to the determination that the updated sample accident probabilities still do not satisfy the preset condition, the processing engine 112 may still update the updated prediction model (i.e., the process 1500 returns to 1510) until the plurality of updated sample accident probabilities satisfy the preset condition.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. For example, the processing engine 112 may update the trained prediction model at a certain time interval (e.g., per month, per two months) based on a plurality of newly obtained historical service orders.

In some embodiments, the present disclosure may also provide a computing device (e.g., the computing device 200 illustrated in FIG. 2) including a processor and a storage storing executable instructions. When executed by the processor, the executable instructions may direct the processor to perform a process (e.g., process 400, process 500, process 600, process 900, process 1000, process 1100, process 1500) described elsewhere in the present disclosure.

In some embodiments, the present disclosure may also provide a computer storage medium including executable instructions. When executed by a processor, the executable instructions may direct the processor to perform a process (e.g., process 400, process 500, process 600, process 900, process 1000, process 1100, process 1500) described elsewhere in the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “some embodiments,” and/or “some embodiments” mean that a particular feature, structure or characteristic described in connection with some embodiments is included in at least one embodiment of the present disclosure. Therefore, it is emphasized and should be appreciated that two or more references to “some embodiments,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1-28. (canceled)

29. A system for allocating service requests, comprising:
a storage medium to store a set of instructions; and
a processor, communicatively coupled to the storage medium, to execute the set of instructions to:
obtain, via a network, service request information associated with a service request to be allocated from a requester terminal and provider information associated with each of a plurality of candidate service providers;
determine a matching degree of each of the plurality of candidate service providers based on the service request information and the provider information;
determine a target service provider based on the matching degree of each of the plurality of candidate service providers; and
transmit data associated with the service request to a target provider terminal corresponding to the target service provider via the network.

30. The system of claim 29, wherein
the service request information includes at least one of a start time, a start location, a city where the service request is initiated, weather information of the city, a density of accidental service orders within a predetermined range of the start location, an estimated mileage, a gender of a service requester, an age of the service requester, historical evaluation information of the service requester, a registration time of the service requester, complaint records of the service requester, or a combination thereof; or
the provider information of each of the plurality of candidate service providers includes at least one of a gender of the candidate service provider, an age of the candidate service provider, historical evaluation information of the candidate service provider, a registration time of the candidate service provider, a service score of the candidate service provider, historical service order records of the candidate service provider, or a combination thereof.

31. The system of claim 29, wherein to determine the matching degree of each of the plurality of candidate service providers based on the service request information and the provider information, the processor is to:
determine an allocation parameter of each of the plurality of candidate service providers based on the service request information and the provider information;
predict a probability of accidents corresponding to each of the plurality of candidate service providers with respect to the service request;
determine a matching weight for each of the plurality of candidate service providers based on the probability of accidents; and
determine the matching degree of each of the plurality of candidate service providers based on the allocation parameter and the matching weight.

32. The system of claim 31, wherein the allocation parameter comprises at least one of a linear distance between a start location of the service request and a location of the candidate service provider, a driving distance between the start location of the service request and the location of the candidate service provider, or an estimated travel time from the location of the candidate service provider to the start location of the service request.

33. The system of claim 31, wherein to determine the matching weight for each of the plurality of candidate service providers based on the probability of accidents, the processor is to:
determine the matching weight as 1 in response to that the probability of accidents is lower than a predetermined threshold; and
determine the matching weight inversely proportional to the probability of accidents in response to that the probability of accidents is larger than or equal to the predetermined threshold.

34. The system of claim 31, wherein to determine the matching degree of each of the plurality of candidate service providers based on the allocation parameter and the matching weight, the processor is to:
determine a preliminary matching degree of each of the plurality of candidate service providers based on the allocation parameter; and
determine the matching degree of each of the plurality of candidate service providers by adjusting the preliminary matching degree based on the matching weight.

35. The system of claim 31, wherein to predict the probability of accidents corresponding to each of the plurality of service providers with respect to the service request, the processor is to:
predict the probability of accidents corresponding to each of the plurality of candidate service providers with respect to the service request using a trained prediction model.

36. The system of claim 35, wherein the trained prediction model is determined using a training process, the training process comprising:
obtaining a plurality of historical service orders;
extracting historical service order information from the plurality of historical service orders;
determining a plurality of samples including a plurality of positive samples and a plurality of negative samples based on historical evaluation information in the historical service order information; and
determining the trained prediction model based on the plurality of positive samples and the plurality of negative samples.

37. The system of claim 36, wherein the determining the trained prediction model based on the plurality of positive samples and the plurality of negative samples comprises:
extracting sample features from each of the plurality of samples;
obtaining a preliminary prediction model;
determining a plurality of sample accident probabilities corresponding to the plurality of samples based on the preliminary prediction model and the sample features;
determining whether the plurality of sample accident probabilities satisfy a preset condition; and
designating the preliminary prediction model as the trained prediction model in response to that the plurality of sample accident probabilities satisfy the preset condition.

38. The system of claim 37, wherein the determining the trained prediction model based on the plurality of positive samples and the plurality of negative samples comprises:
updating the preliminary prediction model in response to that the plurality of sample accident probabilities do not satisfy the preset condition.

39. The system of any of claim 35, wherein the trained prediction model includes an Extreme Gradient Boosting (XGBoost) model.

40. A method implemented on a computing device including at least one processor, at least one storage medium, and a communication platform connected to a network, the method comprising:
obtaining, via the network, service request information associated with a service request to be allocated from a requester terminal and provider information associated with each of a plurality of candidate service providers;
determining a matching degree of each of the plurality of candidate service providers based on the service request information and the provider information;
determining a target service provider based on the matching degree of each of the plurality of candidate service providers; and
transmitting data associated with the service request to a target provider terminal corresponding to the target service provider via the network.

41. The method of claim 40, wherein
the service request information includes at least one of a start time, a start location, a city where the service request is initiated, weather information of the city, a density of accidental service orders within a predetermined range of the start location, an estimated mileage, a gender of a service requester, an age of the service requester, historical evaluation information of the service requester, a registration time of the service requester, complaint records of the service requester, or a combination thereof; or
the provider information of each of the plurality of candidate service providers includes at least one of a gender of the candidate service provider, an age of the candidate service provider, historical evaluation information of the candidate service provider, a registration time of the candidate service provider, a service score of the candidate service provider, historical service order records of the candidate service provider, or a combination thereof.

42. The method of claim 40, wherein the determining the matching degree of each of the plurality of candidate service providers based on the service request information and the provider information comprises:
determining an allocation parameter of each of the plurality of candidate service providers based on the service request information and the provider information;
predicting a probability of accidents corresponding to each of the plurality of candidate service providers with respect to the service request;
determining a matching weight for each of the plurality of candidate service providers based on the probability of accidents; and
determining the matching degree of each of the plurality of candidate service providers based on the allocation parameter and the matching weight.

43. The method of claim 42, wherein the allocation parameter comprises at least one of a linear distance between a start location of the service request and a location of the candidate service provider, a driving distance between the start location of the service request and the location of the candidate service provider, or an estimated travel time from the location of the candidate service provider to the start location of the service request.

44. The method of claim 42, wherein the determining the matching weight for each of the plurality of candidate service providers based on the probability of accidents comprises:
determining the matching weight as 1 in response to that the probability of accidents is lower than a predetermined threshold; and
determining the matching weight inversely proportional to the probability of accidents in response to that the probability of accidents is larger than or equal to the predetermined threshold.

45. The method of claim 42, wherein the determining the matching degree of each of the plurality of candidate service providers based on the allocation parameter and the matching weight comprises:
determining a preliminary matching degree of each of the plurality of candidate service providers based on the allocation parameter; and
determining the matching degree of each of the plurality of candidate service providers by adjusting the preliminary matching degree based on the matching weight.

46. The method of claim 42, wherein the predicting the probability of accidents corresponding to each of the plurality of service providers with respect to the service request comprises:
predicting the probability of accidents corresponding to each of the plurality of candidate service providers with respect to the service request using a trained prediction model.

47. The method of claim 46, wherein the trained prediction model is determined using a training process, the training process comprising:
obtaining a plurality of historical service orders;
extracting historical service order information from the plurality of historical service orders;
determining a plurality of samples including a plurality of positive samples and a plurality of negative samples based on historical evaluation information in the historical service order information; and
determining the trained prediction model based on the plurality of positive samples and the plurality of negative samples.

48. The method of claim 47, wherein the determining the trained prediction model based on the plurality of positive samples and the plurality of negative samples comprises:
extracting sample features from each of the plurality of samples;
obtaining a preliminary prediction model;
determining a plurality of sample accident probabilities corresponding to the plurality of samples based on the preliminary prediction model and the sample features;
determining whether the plurality of sample accident probabilities satisfy a preset condition; and
designating the preliminary prediction model as the trained prediction model in response to that the plurality of sample accident probabilities satisfy the preset condition.

49-62. (canceled)
